(19) United States
(12) Patent Application Publication
(10) Pub. No.: US 2026/0325398 A1
(43) Pub. Date: Oct. 22, 2026

(54) SEXUAL STIMULATION DEVICE

(71) Applicant: Dongguan Pinchen Industrial Design Co., Ltd, Dongguan (CN)

(72) Inventor: Qinling WANG, Heyuan (CN)

(21) Appl. No.: 19/725,061

(22) Filed: Jun. 30, 2026

Related U.S. Application Data
(63) Continuation-in-part of application No. 18/940,784, filed on Nov. 7, 2024.
Application No. 18/940,784 is a continuation-in-part of application No. 18/516,984, filed on Nov. 22, 2023, now Pat. No. 12,161,598.

(30) Foreign Application Priority Data
Jun. 30, 2025 (CN) 202521362196.9

(51) Int. Cl. A61H 19/00; A61H 23/02

(52) U.S. Cl. CPC A61H 19/32; A61H 23/02; A61H 2205/087

(57) ABSTRACT

A sexual stimulation device includes a shell and a massaging portion. The shell defines a massaging space and is made of a flexible material. The shell includes a first contacting portion and a second contacting portion. The first contacting portion and the second contacting portion are substantially breast-shaped. The massaging portion includes a first moving portion and a second moving portion. The first contacting portion covers an outer side of the first moving portion, the second contacting portion covers an outer side of the second moving portion, the first moving portion and the second moving portion are opposite to each other and are spaced apart from each other in a first direction, at least one of the first moving portion and the second moving portion are movably arranged so as to cause the shell to deform, thereby massaging the human body to be massaged located in the massaging space.

### CROSS-REFERENCE TO RELATED APPLICATIONS

This disclosure is a continuation in part application of App. No. 18/940,784, filed on Nov. 7, 2024, which claims priorities of Chinese Patent Application No. 202521362196.9, filed on Jun. 30, 2025, the entire contents of which are hereby incorporated by reference.

### TECHNICAL FIELD

The present disclosure relates to the technical field of adult products, and in particular to a sexual stimulation device.

### BACKGROUND

In recent years, sexual stimulation devices are developed to help the users to release their sex pressure. However, a traditional sexual stimulation device has limitations in structural design, thus the massage device having poor adaptability and being unable to satisfy user demand. Generally, a traditional sexual stimulation device mostly only has vibrational massage function. Due to the presence of only one massage mode, their functionality is limited. Therefore, a traditional sexual stimulation device has unsatisfactory stimulation effect.

### SUMMARY

In view of this, an object of the present disclosure is to provide a sexual stimulation device with enhanced stimulation effect.

To achieve the above object, the present disclosure provides a sexual stimulation device including:
a shell defining a massaging space accommodating a human body and being made of a flexible material, the shell comprising a first contacting portion and a second contacting portion, the massaging space defined at a region between the first contacting portion and the second contacting portion, and each of the first contacting portion and the second contacting portion is substantially breast-shaped; and
a massaging portion comprising a first moving portion and a second moving portion located at two opposite sides of the massaging space;
wherein the first contacting portion covers an outer side of the first moving portion, the second contacting portion covers an outer side of the second moving portion, the first moving portion and the second moving portion are opposite to each other and are spaced apart from each other in a first direction, at least one of the first moving portion and the second moving portion are movably arranged so as to cause the shell to deform, thereby massaging the human body located in the massaging space.

In another aspect, an embodiment of the present disclosure further provides another sexual stimulation device including a massaging portion. The massaging portion includes a first moving portion and a second moving portion spaced apart from each other. Outer surfaces of the first moving portion and the second moving portion being covered with a shell made of a flexible material. Wherein at least one of the first moving portion and the second moving portion is movably arranged to perform back-and-forth massage or left-right squeezing massage on a human body located between the first moving portion and the second moving portion. The shell is configured to directly contact the human body, and to perform back-and-forth friction massage or left-right squeezing massage on the human body located between the first moving portion and the second moving portion as the first moving portion and/or the second moving portion moves.

When the present sexual stimulation device is in use, a male penis or other human body to be massaged may be inserted into the massaging space, and the movement of the massaging portion massages the human body to be massaged. The massaging portion can massage a relatively large area covering the movement trajectory of the massaging portion, and the shell can massage the human body from at least one side, achieving a better massage effect and providing a good user experience.

### BRIEF DESCRIPTION OF DRAWINGS

In order to illustrate the technical solution in embodiments of the present disclosure more clearly, the following briefly introduces accompanying drawings used in the description of the embodiments. Obviously, the accompanying drawings in the following description are only some embodiments of the present disclosure. Those of ordinary skill in the art can obtain other accompanying drawings from these accompanying drawings without any creative efforts.

FIG. 1 is a perspective view of a sexual stimulation device according to a first embodiment of the present disclosure.

FIG. 2 is a perspective view of the sexual stimulation device of FIG. 1 viewed from another direction.

FIG. 3 is a cross-sectional view of the sexual stimulation device of FIG. 1.

FIG. 4 is an exploded view of the sexual stimulation device of FIG. 1 viewed from one direction.

FIG. 5 is an exploded view of the sexual stimulation device of FIG. 1 viewed from another direction.

FIG. 6 is an exploded view of a first driving mechanism and a second driving mechanism of the sexual stimulation device of FIG. 1 viewed from one direction.

FIG. 7 is an exploded view of the first driving mechanism and the second driving mechanism of the sexual stimulation device of FIG. 1 viewed from another direction.

FIG. 8 is a schematic view of the first driving mechanism of another embodiment of the sexual stimulation device of FIG. 1.

FIG. 9 is a schematic view of the first driving mechanism of yet another embodiment of the sexual stimulation device of FIG. 1.

FIG. 10 is a schematic view showing the sexual stimulation device of FIG. 1 being in use.

FIG. 11a is a schematic view of a sexual stimulation device according to a second embodiment of the present disclosure showing the massaging space defined in the top of the third contacting portion.

FIG. 11b is a schematic view of a sexual stimulation device according to a second embodiment of the present disclosure showing the massaging space defined in the front side of the third contacting portion.

FIG. 12 is a perspective view of a sexual stimulation device according to a third embodiment of the present disclosure.

FIG. 13 is a perspective view of the sexual stimulation device of FIG. 12 viewed from another direction.

FIG. 14 is a cross-sectional view of the sexual stimulation device of FIG. 12.

FIG. 15 is an exploded view of the sexual stimulation device of FIG. 12 viewed from one direction.

FIG. 16 is an exploded view of the sexual stimulation device of FIG. 12 viewed from another direction.

FIG. 17 is an exploded view of a first driving mechanism of the sexual stimulation device of FIG. 12 viewed from one direction.

FIG. 18 is an exploded view of the first driving mechanism of the sexual stimulation device of FIG. 12 viewed from another direction.

FIG. 19 is a cross-sectional view of the first driving mechanism of the sexual stimulation device of FIG. 12.

FIG. 20 is a perspective view of a sexual stimulation device according to a fourth embodiment of the present disclosure.

FIG. 21 is a perspective view of the sexual stimulation device of FIG. 20 viewed from another direction.

FIG. 22 is a cross-sectional view of the sexual stimulation device of FIG. 20.

FIG. 23 is an exploded view of the sexual stimulation device of FIG. 20 viewed from one direction.

FIG. 24 is an exploded view of the sexual stimulation device of FIG. 20 viewed from another direction.

FIG. 25 is an exploded view of a first driving mechanism of the sexual stimulation device of FIG. 20 viewed from one direction.

FIG. 26 is an exploded view of the first driving mechanism of the sexual stimulation device of FIG. 20 viewed from another direction.

FIG. 27 is a perspective view of a sexual stimulation device according to a fifth embodiment of the present disclosure.

FIG. 28 is a top plan view of the sexual stimulation device of FIG. 27.

FIG. 29 is a cross-sectional view of the male sexual stimulation device taken along line III-III of FIG. 28.

FIG. 30 is a cross-sectional view of the male sexual stimulation device taken along line IV-IV of FIG. 28.

FIG. 31 is a cross-sectional view of the male sexual stimulation device taken along line V-V of FIG. 28.

FIG. 32 is an exploded view of the male sexual stimulation device of FIG. 27.

FIG. 33 is a further exploded view of the male sexual stimulation device of FIG. 27, wherein an outer shell and an upper portion of an inner shell are removed.

FIG. 34a is an exploded view of a first stimulation module of the male sexual stimulation device of FIG. 27.

FIG. 34b is an exploded view of the first stimulation module from another aspect.

FIG. 35a is a schematic view of an alternative embodiment of a swinging unit of the first stimulation module.

FIG. 35b is a schematic view of a third embodiment of the swinging unit.

FIG. 35c is a schematic view of a fourth embodiment of the swinging unit.

FIG. 35d is a schematic view of a fifth embodiment of the swinging unit.

FIG. 36a is an exploded view of a second stimulation module of the male sexual stimulation device of FIG. 27.

FIG. 36b is an exploded view of the second stimulation module from another aspect.

FIG. 37 is a perspective view of a sexual stimulation device according to a sixth embodiment of the present disclosure.

FIG. 38 is a cross-sectional view of the sexual stimulation device of FIG. 37.

FIG. 39 is an exploded view of the sexual stimulation device of FIG. 37 viewed from one direction.

FIG. 40 is an exploded view of the sexual stimulation device of FIG. 37 viewed from another direction.

FIG. 41 is an exploded view of a first driving mechanism of the sexual stimulation device of FIG. 37 viewed from one direction.

FIG. 42 is an exploded view of the first driving mechanism of the sexual stimulation device of FIG. 37 viewed from another direction.

### DESCRIPTION OF EMBODIMENTS

The embodiments of the present disclosure are described in detail below, examples of which are illustrated in the accompanying drawings, wherein the same or similar reference numerals throughout indicate the same or similar elements or elements having the same or similar functions. The embodiments described below with reference to the accompanying drawings are exemplary and are intended to explain the embodiments of the present disclosure, and shall not be construed as limiting the present disclosure.

In the specification, the oriental or positional relationships indicated by the terms “longitudinal”, “transverse”, “top”, “bottom”, “inner”, “outer”, “central”, “axial”, ”radial”, “circumferential” and the like are only intended to facilitate the description of the present disclosure and simplify the description based on oriental or positional relationships shown in the accompanying drawings, not to indicate or imply that the apparatus or element referred must have a specific orientation, is constructed and operated in a specific orientation, and therefore cannot be understood as a limitation of the present disclosure.

The terms “first”, “second”, “third” and so forth are used only for distinguishing similar elements from each other, rather than for indicating or implying relative importance or specific sequence between these elements. Thus, a feature defined as "first" or "second" may explicitly or implicitly include one or more of such features. In the description of the embodiments of the present disclosure, "a plurality of" means two or more than two, unless otherwise expressly and specifically defined.

Unless otherwise explicitly specified and defined, the terms “arranged”, “connection”, “connected”, “fixed” and the like shall be understood in broad sense, which may, for example, refer to fixed connection, detachable connection or integral connection; may refer to mechanical connection or electrical connection; and may refer to direct connection or indirect connection through an intermediate medium. A person of ordinary skill in the art can understand the specific meaning of the terms in the present application according to specific situations.

### First Embodiment

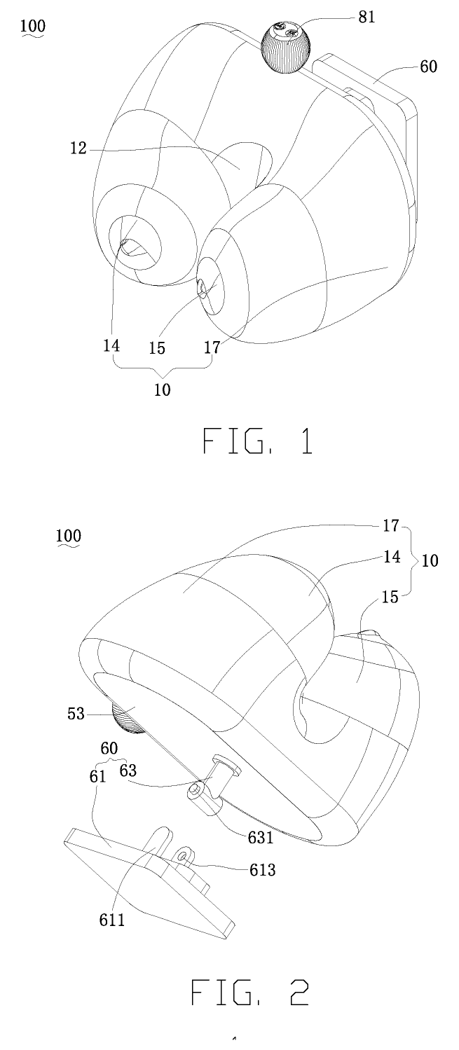

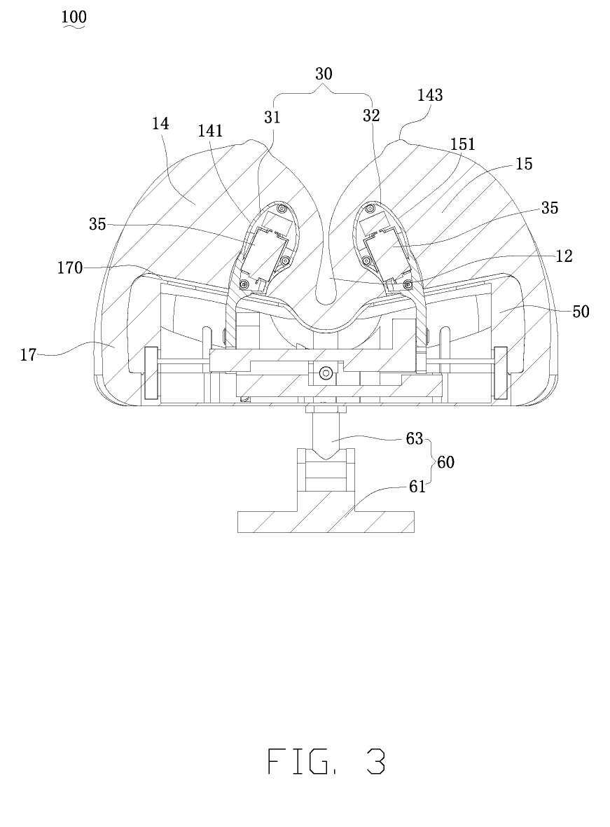

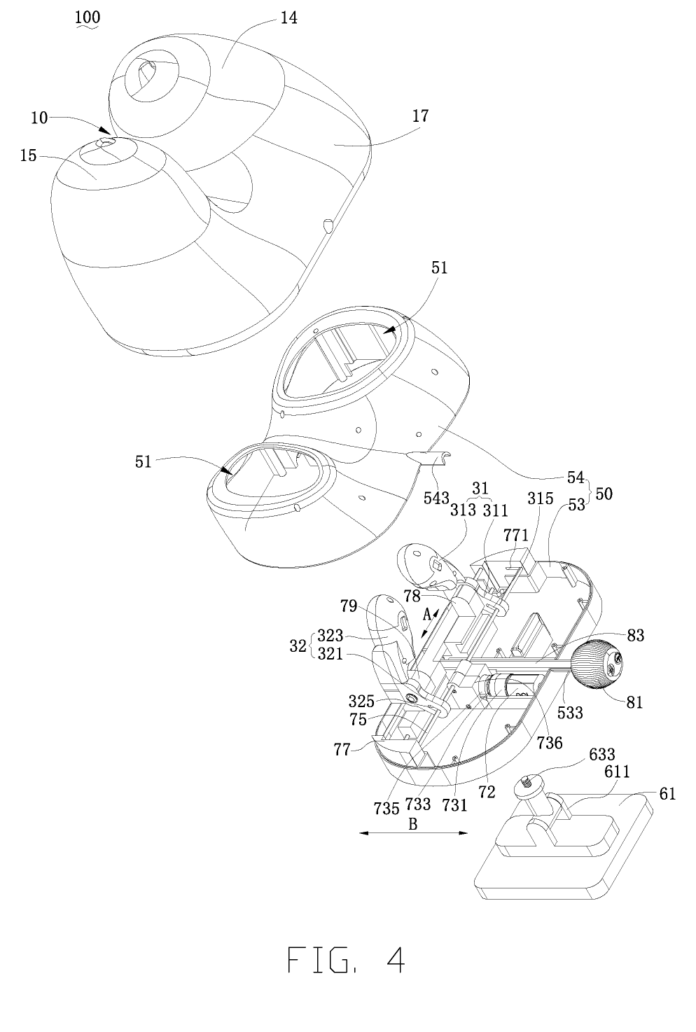

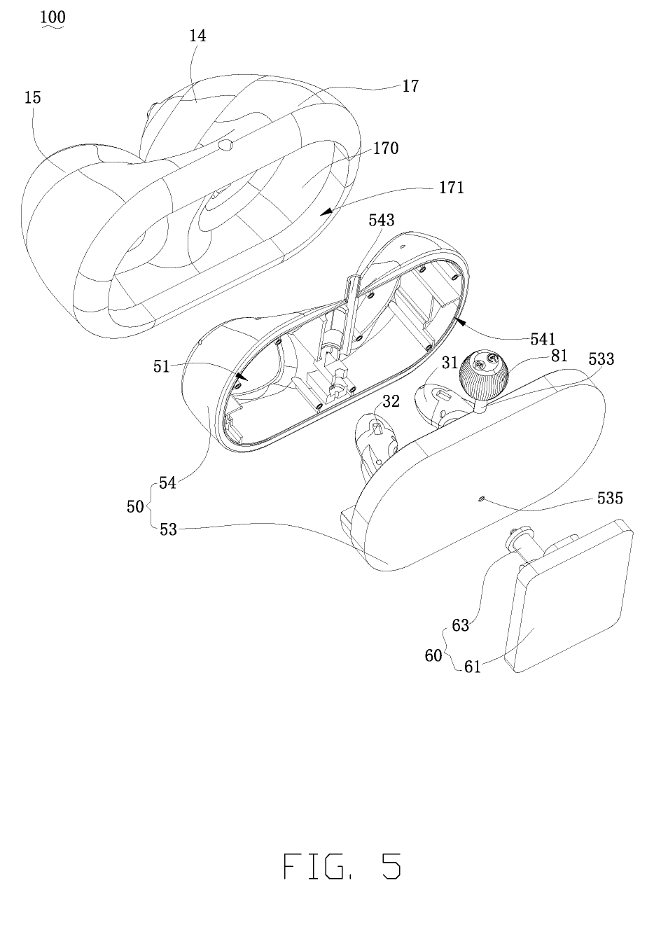

In a first embodiment of the present disclosure, as shown in FIGS. 1 to 5, a sexual stimulation device 100 is provided. The sexual stimulation device 100 includes a shell 10 and a massaging portion 30. The shell 10 defines a massaging space 12 for accommodating a male penis or other human body to be massaged. The shell 10 is made of a flexible material. The massaging portion 30 includes a first moving portion 31 and a second moving portion 32 located on two sides of the massaging space 12 respectively. The first moving portion 31 and the second moving portion 32 are opposite to each other and spaced apart from each other in a first direction A. The shell 10 covers outer sides of the first moving portion 31 and the second moving portion 32. At least one of the first moving portion 31 and the second moving portion 32 is movably arranged so as to cause the shell 10 to deform, thereby massaging the human body to be massaged located in the massaging space 12.

When the sexual stimulation device 100 of this embodiment is in use, a male penis or other human body to be massaged may be inserted into the massaging space 12, and the movement of the massaging portion 30 massages the human body to be massaged. The massaging portion 30 can massage a relatively large region covering the movement trajectory of the massaging portion 30, and at least one side of the human body can be massaged by the shell 10, achieving a better massage effect and providing a good user experience.

In some embodiments, the at least one of the first moving portion 31 and the second moving portion 32 is swingable in a plane perpendicular to the first direction A, so as to perform back-and-forth massage on the human body located in the massaging space 12, achieving a better massage effect and providing a good user experience.

In some embodiments, the first moving portion 31 and the second moving portion 32 are rotatable around the first direction A within a certain angular range (an angular range of less than 360 degrees) so as to perform reciprocating swing, thereby causing a position of at least one of the first moving portion 31 and the second moving portion 32 to vary in a second direction B (i.e., a front-rear direction) intersecting the first direction A. It should be understood that the first direction A and the second direction B are arranged at an angle. Specifically, in this embodiment, the angle between the first direction A and the second direction may be 90°.

In some embodiments, the shell 10, as a component of the sexual stimulation device 100 that directly acts on the human body, may be made of soft materials such as silicone or rubber, and has a certain flexibility. The soft shell 10 provides a soft touch when acting on the human body, can provide a certain cushioning effect, increases massage comfort, and can undergo certain deformation when the first moving portion 31 and the second moving portion 32 of the massaging portion 30 move.

In some embodiments, the shell 10 includes a first contacting portion 14 and a second contacting portion 15. The first contacting portion 14 and the second contacting portion 15 are spaced apart and opposite to each other. The massaging space 12 is defined at a region between the first contacting portion 14 and the second contacting portion 15. Specifically, a first accommodating cavity 141 and a second accommodating cavity 151 are defined in the first contacting portion 14 and the second contacting portion 15 respectively. The first moving portion 31 and the second moving portion 32 are disposed in the first accommodating cavity 141 of the first contacting portion 14 and the second accommodating cavity 151 of the second contacting portion 15 respectively, so that the first contacting portion 14 and the second contacting portion 15 deform with the movement of the first moving portion 31 and the second moving portion 32 to form a massage action. In this embodiment, distal ends of the first contacting portion 14 and the second contacting portion 15 are inclined toward each other. Specifically, the massaging space 12 is a gap defined between the first contacting portion 14 and the second contacting portion 15.

Specifically, the outer surfaces of the first moving portion 31 and the second moving portion 32 are in contact with the inner surfaces of the first accommodating cavity and the second contacting portion respectively. Accordingly, the movement of the first moving portion 31 and the second moving portion 32 causes the soft shell 10 to deform.

Specifically, the first contacting portion 14 and the second contacting portion 15 may be substantially frustoconical to simulate female breasts. The first contacting portion 14 and the second contacting portion 15 are designed to simulate the shape of human body, it can provide a better visual effect and tactile sensation, achieving a better sexual stimulation effect. More specifically, in this embodiment, tops of the first contacting portion 14 and the second contacting portion 15 each form a protrusion 143 resembling a female nipple. It should be understood that the first contacting portion 14 and the second contacting portion 15 may also be cylindrical, spherical, or other shapes, which are not limited herein.

Specifically, a vibration member 35 may be provided in at least one of the first moving portion 31 and the second moving portion 32. The vibration member may be a vibration motor or a vibration actuator. Specifically, in this embodiment, a first cavity (not labeled) and a second cavity are provided in the first moving portion 31 and the second moving portion 32 respectively to accommodate one vibration member 35 each. By providing the vibration member, vibration massage can be performed simultaneously with the reciprocating movement massage of the first moving portion 31 and the second moving portion 32, improving user experience. Alternatively, a retractable member (such as a linear motor) may be provided in at least one of the first contacting portion 14 and the second contacting portion 15.

Specifically, the first moving portion 31 includes a first connecting portion 311 and a first acting portion 313 connected obliquely to the first connecting portion 311. The second moving portion 32 includes a second connecting portion 321 and a second acting portion 323 connected obliquely to the second connecting portion 321. The first acting portion 313 and the second acting portion 323 are configured to move to drive the first contacting portion 14 and the second contacting portion 15 to move, thereby massaging the human body.

Specifically, each of the first acting portion 313 and the second acting portion 323 may be formed by two interlocking parts, so as to facilitate the installation of components. For example, during assembly of the vibration member, the vibration member may be disposed inside a first part of the first acting portion 313 or the second acting portion 323, and then a second part of the first acting portion 313 or the second acting portion 323 is interlocked with the first part.

Specifically, the shell 10 further includes a base portion 17. The first contacting portion 14 and the second contacting portion 15 protrude from a top of the base portion 17. A cavity 170 communicating with the first accommodating cavity 141 and the second accommodating cavity 151 is defined in the base portion 17. Specifically, an opening 171 communicating with the cavity 170 is provided at a bottom of the base portion 17.

In some embodiments, the sexual stimulation device 100 further includes an inner shell 50. The inner shell 50 is a rigid inner shell, and the base portion 17 of the shell 10 covers an outer side of the inner shell 50. The inner shell 50 is disposed in the cavity 170 of the base portion 17. The inner shell 50 is configured to provide support for internal components. Specifically, the inner shell 50 is a hollow shell to accommodate internal components. Two ports 51 are provided at a top of the inner shell 50. A part of the first moving portion 31 and a part of the second moving portion 32 pass through the two ports 51 from the inner shell 50 into the first contacting portion 14 and the second contacting portion 15 respectively. The inner shell 50 is installed into the shell 10 from the opening 171 of the base portion 17.

Specifically, the inner shell 50 includes a bottom shell 53 and a top shell 54 that are interlocked with each other. A bottom of the top shell 54 is open to form an aperture 541, and the bottom shell 53 covers the aperture 541.

Specifically, a first extension portion 543 protrudes from the bottom of the top shell 54, and a second extension portion 533 protrudes from a top of the bottom shell 53. More specifically, the first extension portion 543 and the second extension portion 533 are each a shell with a slot on one side, and the first extension portion 543 and the second extension portion 533 are interlocked to form a cylindrical hollow shell.

In some embodiments, the sexual stimulation device 100 further includes a bracket assembly 60 connected to a bottom of the inner shell 50 to support the sexual stimulation device 100. The bracket assembly 60 can facilitate holding of the sexual stimulation device 100 by a user. It should be understood that in other embodiments, the bracket assembly 60 may be omitted; in yet other embodiments, the bracket assembly 60 may be replaced by other support structures connected to the inner shell 50, such as a strap, which can be tied to other equipment or the user's body to free the hands during use.

Specifically, the bracket assembly 60 includes a base frame 61 and a rotating frame 63. The rotating frame 63 is rotatably connected to the base frame 61. More specifically, the base frame 61 is provided with two lugs 611 spaced apart from each other, and each lug 611 is provided with a lug hole 613. The rotating frame 63 is fixedly connected to the inner shell 50, and each of two sides of the rotating frame 63 is provided with a rotating post 631. The rotating posts 631 are rotatably engaged with the lug holes 613. Thus, the massaging portion 30 and the shell 10 are rotatable relative to the base frame 61, thereby adjusting the angle of the massaging portion 30 and the shell 10 for convenient use. It should be understood that the base frame 61 and the rotating frame 63 may also be connected via a universal joint structure, so that the massaging portion 30 and the shell 10 have a wider range of angle adjustment. One end of the rotating frame 63 is provided with a threaded portion 633, and a threaded hole 535 is provided at a bottom of the bottom shell 53. The rotating frame 63 and the bottom shell 53 may be connected via the threaded portion 633 and the threaded hole 535.

In this embodiment, the sexual stimulation device 100 further includes a first driving mechanism 70. The first driving mechanism 70 is connected to the first moving portion 31 and the second moving portion 32 and drives the first moving portion 31 and the second moving portion 32 to move. In another embodiment, the first driving mechanism 70 may be connected to one of the first moving portion 31 and the second moving portion 32 and drives one of the first moving portion 31 and the second moving portion 32 to move.

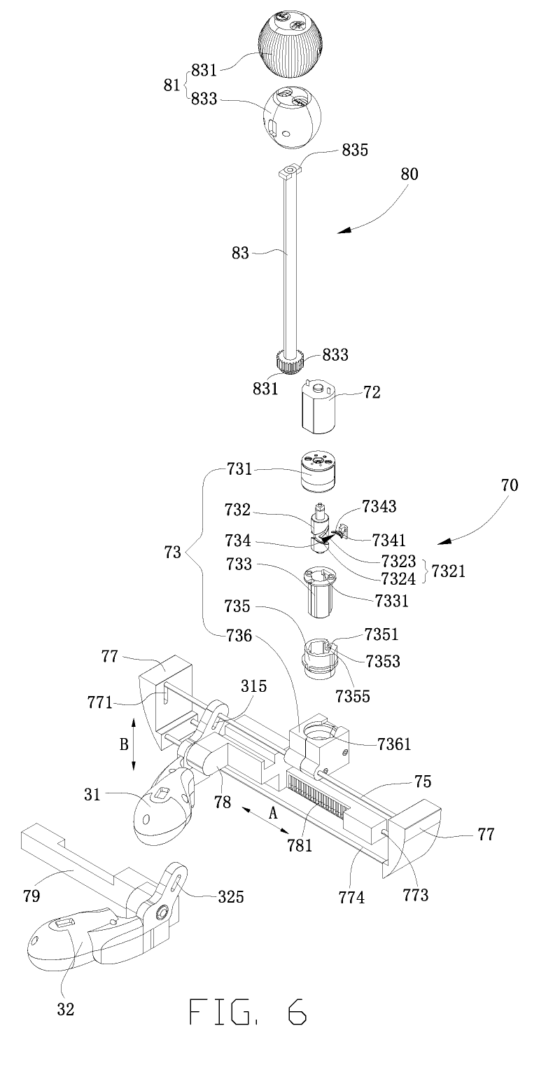

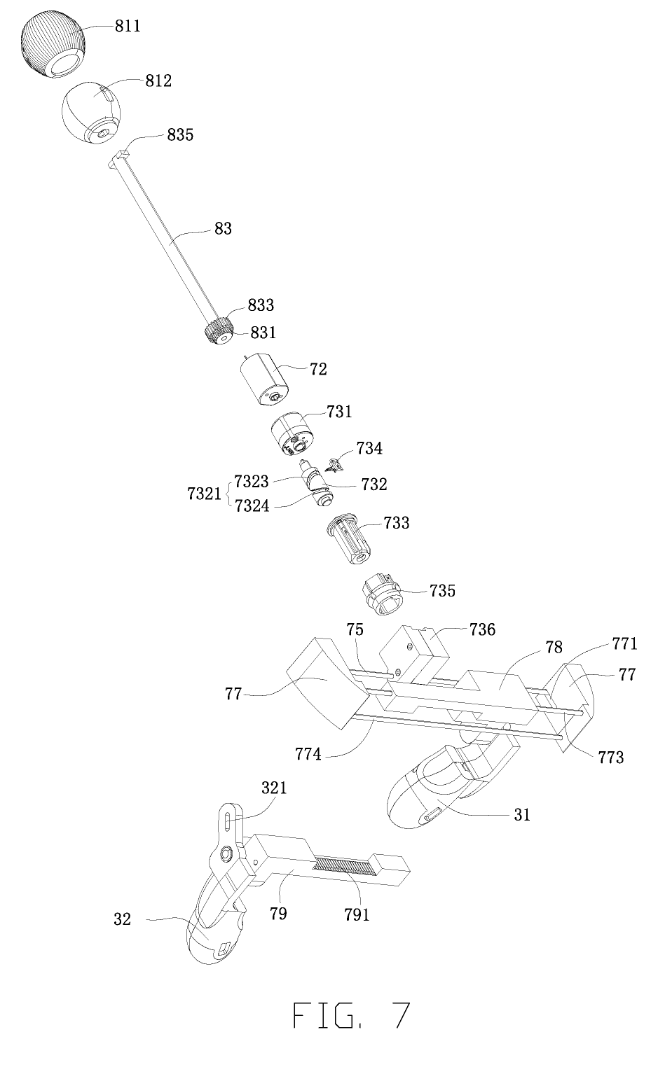

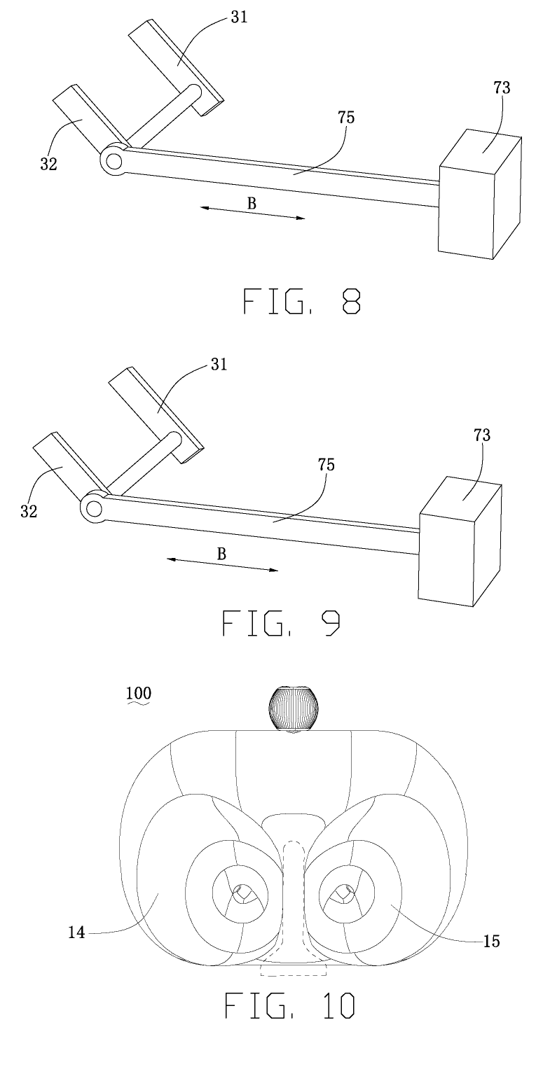

Specifically, referring also to FIG. 6 and FIG. 7, the first driving mechanism 70 includes a first driving member 72, a first transmission mechanism 73, and a sliding push rod 75. The first transmission mechanism 73 is connected to the first driving member 72 and the sliding push rod 75. The first driving member 72 is configured to drive the sliding push rod 75 to perform linear reciprocating movement along the second direction B through the first transmission mechanism 73. The first moving portion 31 and the second moving portion 32 are connected to the sliding push rod 75. Specifically, in this embodiment, each of the first moving portion 31 and the second moving portion 32 is rotatable around an axis parallel to the first direction A. The movement of the sliding push rod 75 is capable of driving the first moving portion 31 and the second moving portion 32 to rotate round the axes parallel to the first direction A. The first moving portion 31 and the second moving portion 32 are provided with a first guide slot 315 and a second guide slot 325 respectively. The sliding push rod 75 is movably inserted into the first guide slot 315 and the second guide slot 325, so as to drive the first moving portion 31 and the second moving portion 32 to rotate about axes parallel to the first direction A to perform a reciprocating swing. In this embodiment, the first driving mechanism 70 drives the first moving portion 31 and the second moving portion 32 to swing in the same direction (i.e., both the first moving portion 31 and the second moving portion 32 swing forward or backward simultaneously). It should be understood that in other embodiments, the first moving portion 31 and the second moving portion 32 may swing in opposite directions (i.e., when one of the first moving portion 31 and the second moving portion 32 swings forward, the other swings backward). It should be understood, as shown in FIG. 8, in another embodiment, the first moving portion 31 and the second moving portion 32 may be directly fixedly connected to the sliding push rod 75 driven by the first transmission mechanism 73 to perform a reciprocating slide, so as to drive the first moving portion 31 and the second moving portion 32 to perform a reciprocating swing. As shown in FIG. 9, in yet another embodiment, the first driving member 72 may drive the first moving portion 31 and the second moving portion 32 to move through a linkage mechanism. Specifically, the linkage mechanism includes a first link 73a with one end connected to the first driving member 72, a second link 73b with one end hinged to the other end of the first link 73a, and a third link 73c with one end hinged to the other end of the second link 73b. The first moving portion 31 and the second moving portion 32 are connected to the other end of the third link 73c. In the embodiments shown in FIGS. 6, 8, and 9, the first moving portion 31 and the second moving portion 32 are driven by the same driving member; it should be understood that in other embodiments, the first moving portion 31 and the second moving portion 32 may also be driven by two driving members respectively. The first driving member 72 may be a motor.

Specifically, in this embodiment, the first transmission mechanism 73 includes a first reduction mechanism 731, a screw rod 732, a sliding guide member 733, a pin 734, a slider 735, and a connecting block 736. An output shaft of the first driving member 72 is connected to an input end of the first reduction mechanism 731 to drive the first reduction mechanism 731 to rotate. The screw rod 732 is connected to an output end of the first reduction mechanism 731 to rotate with the first reduction mechanism 731. The pin 734 engages with a thread of the screw rod 732 to move along the spiral thread as the screw rod 732 rotates (i.e., the screw rod 732 and the pin 734 form a screw-nut structure). The pin 734 is connected to the slider 735, the slider 735 is fixedly connected to the connecting block 736, and the connecting block 736 is fixedly connected to the sliding push rod 75 to drive the sliding push rod 75 to move together along the second direction B. The sliding guide member 733 is fixed relative to a housing of the first reduction mechanism 731. The screw rod 732 runs through the sliding guide member 733, and the slider 735 is slidably sleeved on the sliding guide member 733 so as to move guided by the sliding guide member 733. More specifically, the first reduction mechanism 731 may include a group of gears.

More specifically, a threaded groove 7321 is defined on an outer peripheral surface of the screw rod 732. The pin 734 includes a locking portion 7341 and an insertion portion 7343 fixedly connected to each other. The insertion portion 7343 is movably disposed in the threaded groove 7321, and the locking portion 7341 is inserted into a slot 7351 of the slider 735. The threaded groove 7321 includes a first groove portion 7323 and a second groove portion 7324 in communication with each other. The first groove portion 7323 extends spirally from a first end to a second end of the screw rod 732, and the second groove portion 7324 extends spirally from the second end to the first end of the screw rod 732. Thus, when the first driving member 72 drives the screw rod 732 to rotate continuously in the same direction, the pin 734 can be driven to perform a reciprocating movement in opposite directions, thereby driving the first moving portion 31 and the second moving portion 32 to perform a reciprocating swing. An outer cross-sectional profile of the sliding guide member 733 is non-circular, such as hexagonal, and a cross-sectional profile of an inner hole of the slider 735 corresponds to the outer cross-sectional profile of the sliding guide member 733, so that the sliding guide member 733 and the slider 735 are non-rotatable relative to each other and can only slide relative to each other. More specifically, a sliding slot 7331 is provided on an outer peripheral wall of the sliding guide member 733, and a first protrusion 7353 for engaging with the sliding slot 7331 is provided on an inner peripheral wall of the slider 735, so that the sliding guide member 733 guides the sliding of the slider 735. The sliding guide member 733 may be fixedly connected to a housing of the first reduction mechanism 731. The slider 735 is at least partially sleeved in the connecting block 736 in a non-rotatable manner. Specifically, a second protrusion 7355 is provided on an outer peripheral wall of the slider 735, and a clamping groove 7361 cooperating with the second protrusion 7355 is provided on an inner peripheral wall of the connecting block 736, so that the slider 735 and the connecting block 736 are non-rotatably connected. Specifically, the connecting block 736 defines a through hole, and the sliding push rod 75 extends through the through hole of the connecting block 736 to move along the second direction together with the connecting block 736.

Specifically, the first driving mechanism 70 further includes an end block 77 fixedly connected to the inner shell 50. The end block 77 is provided with a guide groove 771 extending along the second direction B, and the sliding push rod 75 is movably inserted into the guide groove 771.

In the embodiment shown in FIG. 6 and FIG. 7, the first moving portion 31 is hinged to a first base block 78, and the second moving portion 32 is hinged to a second base block 79. Specifically, a connection between the first connecting portion 311 and the first acting portion 313 of the first moving portion 31 is hinged to the first base block 78, and a connection between the second connecting portion 321 and the second acting portion 323 of the second moving portion 32 is hinged to the second base block 79. It should be understood that in the embodiment shown in FIG. 8, the first moving portion 31 and the second moving portion 32 are linearly movable, and in this case, the first base block 78 may be fixedly connected to the first moving portion 31, and the second base block 79 may be fixedly connected to the second moving portion 32.

In this embodiment, the sexual stimulation device 100 further includes a second driving mechanism 80. At least one of the first base block 78 and the second base block 79 is movable toward or away from the other in the first direction A. The second driving mechanism 80 is connected to at least one of the first base block 78 and the second base block 79 to drive the at least one of the first base block 78 and the second base block 79 to move in the first direction A. Thus, the first base block 78 and the second base block 79 is capable of moving closer to or away from each other, thereby driving the first moving portion 31 and the second moving portion 32 to move closer to or away from each other in the first direction A, adjusting a width of the massaging space 12 to accommodate human bodies with different sizes, and also allowing adjustment of the massage effect according to user needs. Specifically, in this embodiment, both the first base block 78 and the second base block 79 are movable in the first direction A. A first guide rod 773 and a second guide rod 774 extending along the first direction A are connected between the two end blocks 77. The first base block 78 is slidably sleeved over the first guide rod 773, and the second base block 79 is slidably sleeved over the second guide rod 774.

Specifically, the second driving mechanism 80 includes an operating handle 81 and a driving rod 83. A first end of the driving rod 83 is connected to the operating handle 81. A second end of the driving rod 83 is in transmission connection with the first base block 78 and the second base block 79, and is capable of driving the first base block 78 and the second base block 79 to move in opposite directions during movement. More specifically, the second end of the driving rod 83 is provided with a gear 831. The first base block 78 and the second base block 79 are provided with a first rack portion 781 and a second rack portion 791 respectively. The gear 831 is configured to mesh with the first rack portion 781 and the second rack portion 791 respectively, and the first rack portion 781 and the second rack portion 791 are disposed on two opposite sides of the gear 831 respectively. More specifically, the second end of the driving rod 83 is further provided with a locking tooth portion 833 adjacent to the gear 831. The operating handle 81 and the driving rod 83 are movably arranged so that the first rack portion 781 and the second rack portion 791 are selectively engageable with the gear 831 or the locking tooth portion 833. The driving rod 83 is non-rotatable when the locking tooth portion 833 engages with the first rack portion 781 and the second rack portion 791. Thus, when it is necessary to drive the first base block 78 and the second base block 79 to move, the driving rod 83 is pulled to switch the driving rod 83 from a first state where the locking tooth portion 833 engages with the first rack portion 781 and the second rack portion 791 to a second state where the gear 831 engages with the first rack portion 781 and the second rack portion 791. Specifically, the cylindrical hollow shell formed by interlocking the first extension portion 543 and the second extension portion 533 of the inner shell 50 can accommodate the driving rod 83 to support the driving rod 83.

Specifically, the operating handle 81 includes an outer shell 811 and an inner shell 812 disposed within the outer shell 811. The inner shell 812 of the operating handle 81 is relatively fixedly connected to the driving rod 83. More specifically, the inner shell 812 is formed by two interlocking parts to facilitate the fixed installation of an engaging end portion 835 of one end of the driving rod 83 into the inner shell 812.

In some embodiment, the user can manually grip the operating handle 81 and rotate the operating handle 81 and the driving rod 83, thereby driving the first base block 78 and the second base block 79 to move. It should be understood that in other embodiments, the operating handle 81 may be omitted, and a second driving member connected to the driving rod 83 may be provided to drive the driving rod 83 to rotate. In another embodiment, the second driving mechanism 80 may also include an elastic member (not shown), and the operating handle 81 and the driving rod 83 may be omitted. The elastic member is preset to provide an elastic force that tends to bring the first moving portion 31 and the second moving portion 32 closer to each other. In this case, when a human body part is inserted into the massaging space 12, the first moving portion 31 and the second moving portion 32 are pressed by the human body and move away from each other in the first direction A. When the human body is withdrawn from the massaging space 12, the first moving portion 31 and the second moving portion 32 move closer to each other in the first direction A under the elastic force of the elastic member. By providing the elastic member, the first moving portion 31 and the second moving portion 32 may apply a squeezing force to the human body, further improving the massage effect. Specifically, the elastic member may be a tension spring with two ends respectively connected to the first moving portion 31 and the second moving portion 32.

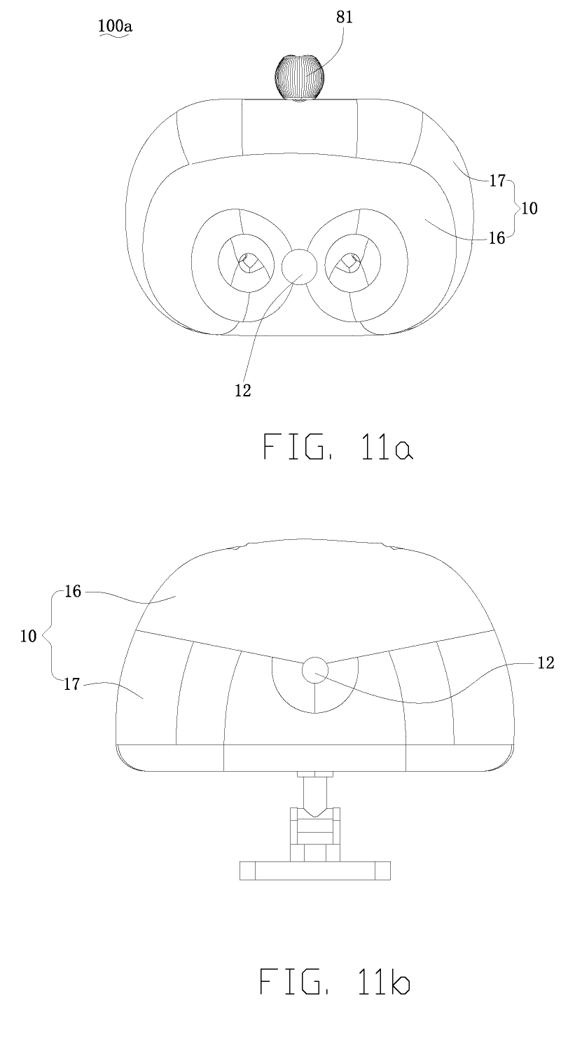

Referring to FIG. 10, when the sexual stimulation device 100 of the first embodiment is in use, a male penis (shown in dashed lines in FIG. 10) or other human body can be inserted into the massaging space 12 from one side of the sexual stimulation device 100. When the first moving portion 31 and the second moving portion 32 move, they drive the first contacting portion 14 and the second contacting portion 15 to rub against the male penis or other human body, thereby achieving massage. Furthermore, when the male penis or other human body is inserted into the massaging space 12, it presses the first contacting portion 14 and the second contacting portion 15 outward, causing deformation of the first contacting portion 14 and the second contacting portion 15. This increases the friction force during massage, enhances the stimulation effect, and improves the massage effect. In addition, by driving at least one of the first moving portion 31 and the second moving portion 32 to move, the distance between the first moving portion 31 and the second moving portion 32 may be adjusted. Thus, the user can set the distance between the first moving portion 31 and the second moving portion 32 according to personal preference to achieve different massage effects. For example, when the distance between the first moving portion 31 and the second moving portion 32 is relatively small, the friction force of the first contacting portion 14 and the second contacting portion 15 against the human body is increased.

### Second Embodiment

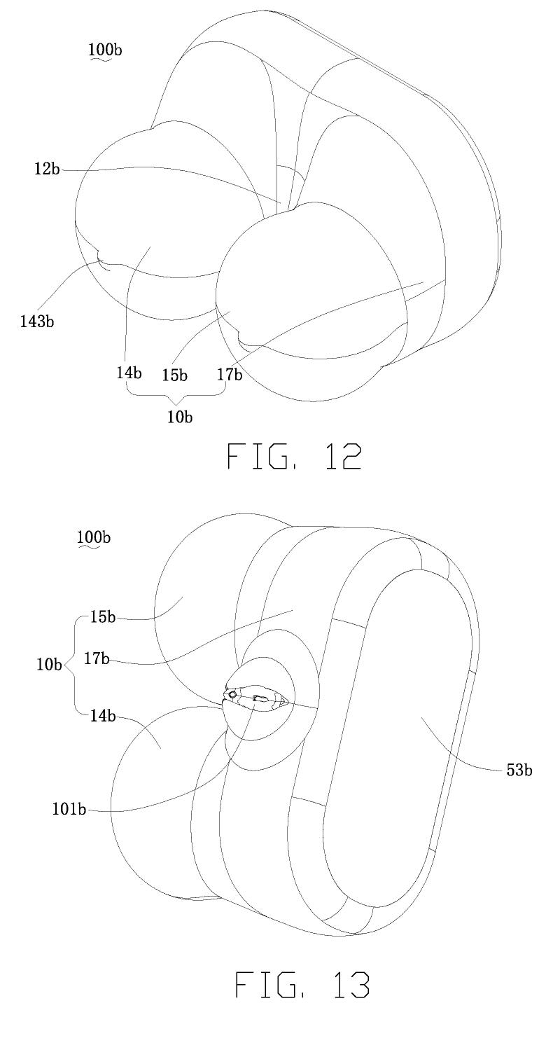

Referring to FIG. 11a and FIG. 11b, a structure of a sexual stimulation device 100a according to a second embodiment of the present disclosure is substantially the same as that of the sexual stimulation device 100 of the first embodiment, with the difference that in the second embodiment, the shell 10 includes a third contacting portion 16 of one piece structure, and a massaging space 12 is defined in the third contacting portion 16 (i.e., an opening is formed in the third contacting portion 16). In other words, the shell 10 is not divided into two spaced-apart contacting portions. Specifically, the first moving portion 31 and the second moving portion 32 are disposed in the first accommodating cavity and the second accommodating cavity of the third contacting portion 16 respectively, so that the third contacting portion 16 moves with the movement of the first moving portion 31 and the second moving portion 32 to perform a massage action. In the embodiment shown in FIG. 11a, a top of the third contacting portion 16 is concavely recessed to define the massaging space 12. In the embodiment shown in FIG. 11b, a front side of the third contacting portion 16 is concavely recessed to define the massaging space 12.

Specifically, the third contacting portion 16 may be substantially frustoconical. More specifically, the third contacting portion 16 is substantially a quadrangular frustum with an inclined top. It should be understood that the third contacting portion 16 may also be cylindrical, spherical, or other shapes, which are not limited herein. The other structures of this embodiment are the same as those of the first embodiment, and are not described again here.

### Third Embodiment

In a third embodiment of the present disclosure, as shown in FIG. 12 to FIG. 14, a sexual stimulation device 100b is provided. The sexual stimulation device includes a shell 10b and a massaging portion 30b. The shell 10 defines a massaging space 12b for accommodating a male penis or other human body to be massaged. The shell 10b is made of a flexible material. The massaging portion 30b includes a first moving portion 31b and a second moving portion 32b located on two sides of the massaging space 12b respectively. The first moving portion 31b and the second moving portion 32b are opposite to each other and spaced apart from each other in a first direction A. The shell 10b covers outer sides of the first moving portion 31b and the second moving portion 32b. At least one of the first moving portion 31b and the second moving portion 32b is movably arranged so as to cause the shell 10b to deform, thereby massaging the human body to be massaged located in the massaging space 12b.

When the sexual stimulation device 100b of this embodiment is in use, a male penis or other human body to be massaged may be inserted into the massaging space 12b, and the movement of the massaging portion 30b massages the human body to be massaged. The massaging portion 30b can massage a relatively large region covering the movement trajectory of the massaging portion 30b, and at least one side of the human body can be massaged by the shell 10b, achieving a better massage effect and providing a good user experience.

In some embodiments, the first moving portion 31b and the second moving portion 32b are swingable towards each other or away from each other to move closer to or away from each other in the first direction A, so as to massage the human body to be massaged located in the massaging space 12b. Thus, the movement of the first moving portion 31b and the second moving portion 32b enables the shell 10b to perform left-right squeezing massage on the human body to be massaged.

In some embodiments, the shell 10b, as a component of the sexual stimulation device 100b that directly acts on the human body, may be made of soft materials such as silicone or rubber, and has a certain flexibility.

In some embodiments, the shell 10b includes a first contacting portion 14b and a second contacting portion 15b. The first contacting portion 14b and the second contacting portion 15b are spaced apart and opposite to each other. The massaging space 12b is defined at a region between the first contacting portion 14b and the second contacting portion 15b. Specifically, a first accommodating cavity 141b and a second accommodating cavity 151b are defined in the first contacting portion 14b and the second contacting portion 15b respectively. The first moving portion 31b and the second moving portion 32b are disposed in the first accommodating cavity 141b of the first contacting portion 14b and the second accommodating cavity 151b of the second contacting portion 15b respectively, so that the first contacting portion 14b and the second contacting portion 15b deform with the movement of the first moving portion 31b and the second moving portion 32b to form a massage action. In this embodiment, distal ends of the first contacting portion 14b and the second contacting portion 15b are inclined toward each other. Specifically, the massaging space 12b is a gap between the first contacting portion 14b and the second contacting portion 15b.

Specifically, the first contacting portion 14b and the second contacting portion 15b may be substantially frustoconical to simulate female breasts. The first contacting portion 14b and the second contacting portion 15b are designed to simulate the shape of human body, it can provide a better visual effect and tactile sensation, achieving a better sexual stimulation effect. More specifically, in this embodiment, a top of each of the first contacting portion 14b and the second contacting portion 15b forms a protrusion 143b resembling a female nipple. It should be understood that the first contacting portion 14b and the second contacting portion 15b may also be cylindrical, spherical, or other shapes, which are not limited herein.

Specifically, a vibration member 35b may be provided in at least one of the first contacting portion 14b and the second contacting portion 15b. The vibration member 35b may specifically be a vibration motor or a vibration actuator. Specifically, in this embodiment, the vibration member 35b is disposed on one side of at least one of the first moving portion 31b and the second moving portion 32b. Alternatively, a retractable member (such as a linear motor) may be provided in at least one of the first contacting portion 14b and the second contacting portion 15b.

Specifically, the shell 10b further includes a base portion 17b. The first contacting portion 14b and the second contacting portion 15b protrude from a top of the base portion 17b. A cavity 170b communicating with the first accommodating cavity 141b and the second accommodating cavity 151b is defined in the base portion 17b. Specifically, an opening 171b communicating with the cavity 170b is provided at a bottom of the base portion 17b.

In some embodiments, a massaging cavity 19b is further provided in the shell 10b, and a massage end 101b communicating with the massaging cavity 19b is formed on an outer surface of the shell 10b. The massage end 101b is located at one end of the massaging cavity 19b, and the massage end 101b may be in the shape of a labia, a mouth, or an anus. The male penis may also be inserted into the massaging cavity 19b through the massage end 101b for massage. Specifically, in this embodiment, another vibration member 35b is provided adjacent to the massaging cavity 19b to generate a vibrating effect and massage the human body to be massaged located in the massaging cavity 19b. The massaging cavity 19b enables more diverse massage manners, thereby enhancing the massage experience. Alternatively, a retractable member (such as a linear motor) may be provided adjacent to the massaging cavity 19b.

Specifically, the massaging cavity 19b may be formed in the base portion 17b. Further, the massaging cavity 19b may extend along a direction perpendicular to the first direction. Specifically, the massaging cavity 19b is defined below the massaging space 12b.

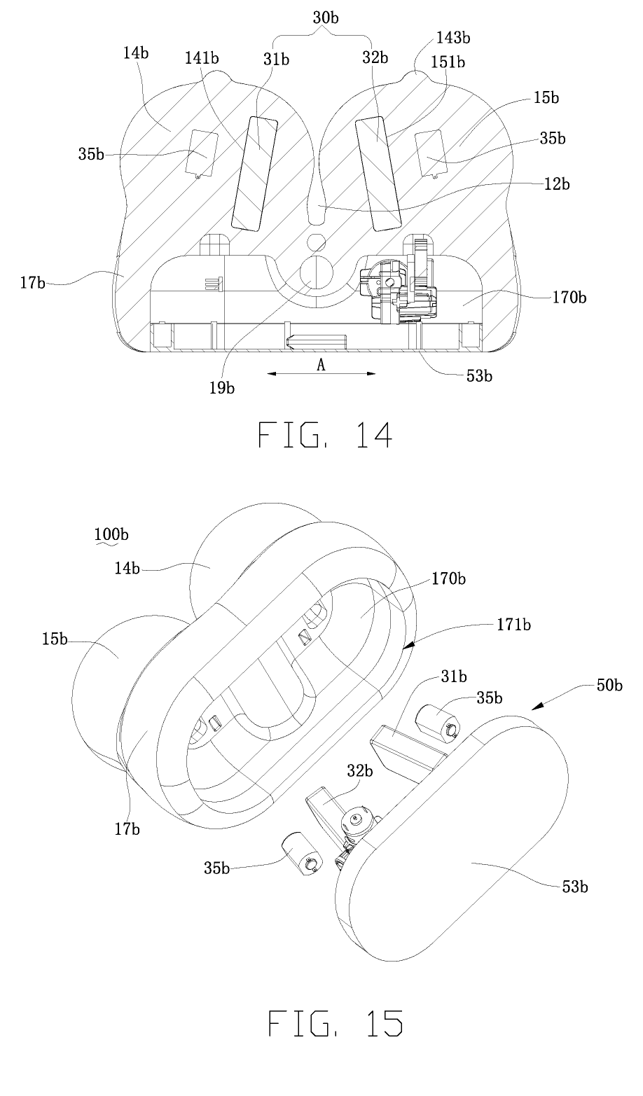

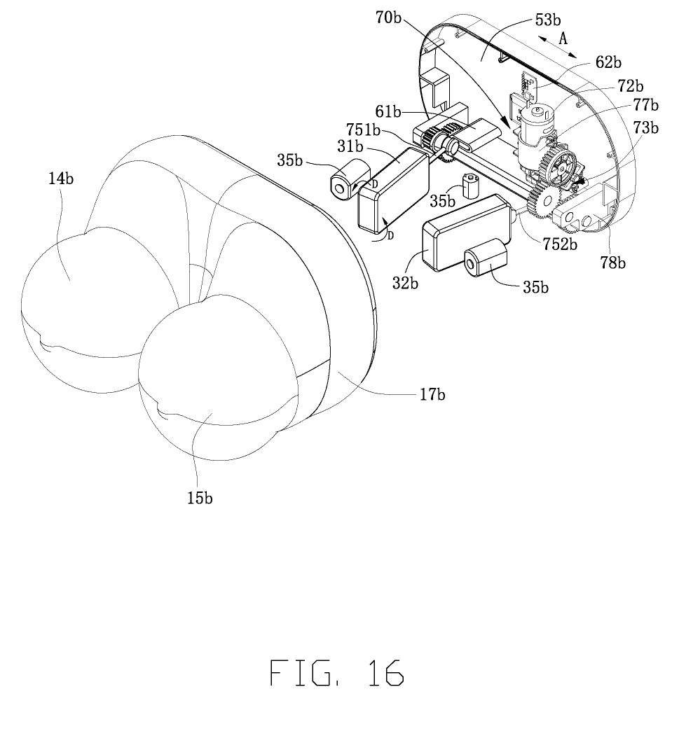

In some embodiments, referring also to FIG. 15 and FIG. 16, the sexual stimulation device 100b further includes an inner shell 50b. The inner shell 50b only includes a bottom shell 53b. The bottom shell 53b is disposed at the opening 171b of the base portion 17b to enclose the cavity 170b.

In some embodiments, a battery 61b and a circuit board 62b may be disposed in the cavity 170b of the base portion 17b. The battery 61b may supply power to the vibration members 35b and a first driving mechanism 70b described below. The circuit board 62b may control the operation of the vibration member 35b and the first driving mechanism 70b according to user instructions.

In some embodiments, the sexual stimulation device 100b further includes a first driving mechanism 70b. The first driving mechanism 70b is connected to at least one of the first moving portion 31b and the second moving portion 32b and drives the first moving portion 31b and the second moving portion 32b to swing towards each other or away from each other. Specifically, the first driving mechanism 70b is disposed in the cavity 170b of the base portion 17b.

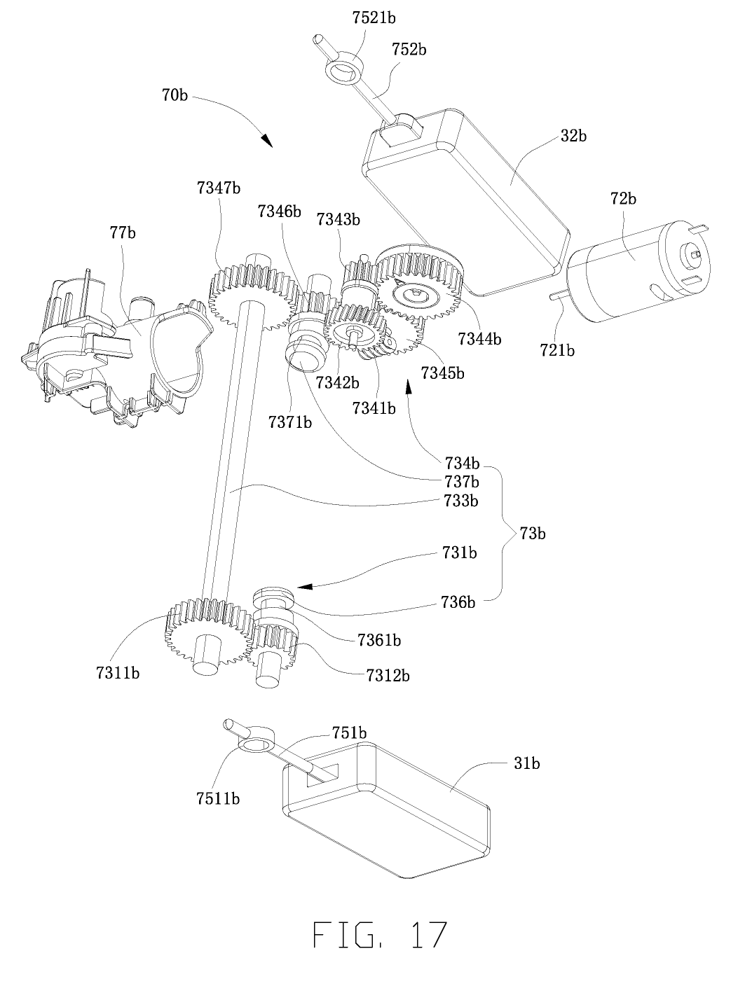

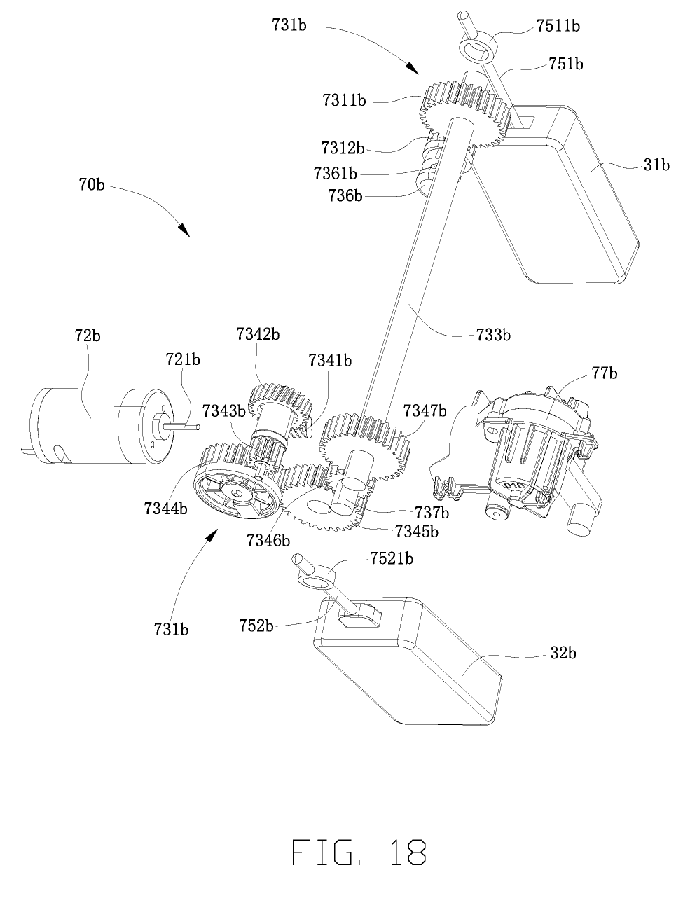

In some embodiments, referring to FIG. 17 and FIG. 18, the first driving mechanism 70b includes a first driving member 72b, a first transmission mechanism 73b, a first swing rod 751b, and a second swing rod 752b. The first transmission mechanism 73b is connected to the first driving member 72b, the first swing rod 751b, and the second swing rod 752b. The first driving member 72b is configured to drive, through the first transmission mechanism 73b, at least one of the first swing rod 751b and the second swing rod 752b to swing. The first moving portion 31b and the second moving portion 32b are connected to the first swing rod 751b and the second swing rod 752b respectively so as to be driven thereby to move closer to or away from each other. Further, the first moving portion 31b and the second moving portion 32b are also driven to rotate around a second direction perpendicular to the first direction A. That is, the first moving portion 31b and the second moving portion 32b are wiggleable (as shown in FIG. 16, the arrow D show the wiggling direction of the first moving portion 31b). Specifically, in this embodiment, the first driving mechanism 70b drives both the first moving portion 31b and the second moving portion 32b to move. It should be understood that in other embodiments, only one of the first moving portion 31b and the second moving portion 32b may be driven to move. In the embodiment shown in the figures, the first moving portion 31b and the second moving portion 32b are driven by the same driving member. It should be understood that in other embodiments, the first moving portion 31b and the second moving portion 32b may also be driven by two driving members respectively. The first driving member 72b may be a motor.

In one embodiment, the first transmission mechanism 73b includes a first gear group 731b, a linkage rod 733b, a second gear group 734b, a first bent shaft 736b, and a second bent shaft 737b. An input end of the second gear group 734b is connected to an output shaft 721b of the first driving member 72b and is driven to rotate by the first driving member 72b. An output end of the first gear group 734b and an input end of the second gear group 731b are connected to the linkage rod 733b respectively. The first bent shaft 736b is connected to the first gear group 731b to be driven to rotate thereby, and the second bent shaft 737b is connected to the second gear group 734b to be driven to rotate thereby. Specifically, the first bent shaft 736b includes a first neck portion 7361b with a smaller diameter. The first swing rod 751b includes a first ring 7511b, and the first ring 7511b is rotatably sleeved over the first neck portion 7361b. The second bent shaft 737b includes a second neck portion 7371b with a smaller diameter. The second swing rod 752b includes a second ring 7521b, and the second ring 7521b is rotatably sleeved over the second neck portion 7371b.

Referring to FIG. 19, each of the first bent shaft 736b and the second bent shaft 737b includes a first shaft portion 738b and a second shaft portion 739b arranged at an angle, i.e., an angle between an extension direction L1 of the first shaft portion 738b and an extension direction L2 of the second shaft portion 739b is greater than 0° and less than 90°, or greater than 90° and less than 180°. The first shaft portion 738b is connected to the first gear group 731b or the second gear group 734b, and the second shaft portion 739b is connected to the first swing rod 751b or the second swing rod 752b. Thus, as the first bent shaft 736b and the second bent shaft 737b rotate, the first swing rod 751b and the second swing rod 752b can swing within a certain range. In FIG. 19, as the second bent shaft 737b rotates, the second moving portion 32b is illustrated in solid lines in a first position and in dashed lines in a second position.

Specifically, the first gear group 731b includes a first gear 7311b and a second gear 7312b meshing with each other. The first gear 7311b is fixedly connected to the linkage rod 733b, and the first bent shaft 736b is fixedly connected to the second gear 7312b. The second gear group 734b includes a worm 7341b, a worm wheel 7342b meshing with the worm 7341b, a third gear 7343b coaxially disposed with the worm wheel 7342b, a fourth gear 7344b meshing with the third gear 7343b, a fifth gear 7345b meshing with the fourth gear 7344b, a sixth gear 7346b meshing with the fifth gear 7345b, and a seventh gear 7347b meshing with the sixth gear 7346b. The seventh gear 7347b is fixedly connected to the linkage rod 733b, and the sixth gear 7346b is fixedly connected to the second bent shaft 737b.

In this embodiment, the first driving mechanism 70b further includes a mounting seat 77b and a mounting frame 78b installed on the bottom shell 53b. The first driving member 72b is installed on the mounting seat 77b. The mounting seat 77b is configured to support components such as the worm wheel 7342b and the third gear 7343b. The mounting frame 78b is configured to support components such as the linkage rod 733b, the first bent shaft 736b, and the second bent shaft 737b.

It should be understood that the sexual stimulation device 100b may further include a bracket assembly connected to a bottom of the inner shell 50b to support the sexual stimulation device 100b. The bracket assembly may have a structure the same as a structure of the bracket assembly 60 of the first embodiment.

### Fourth Embodiment

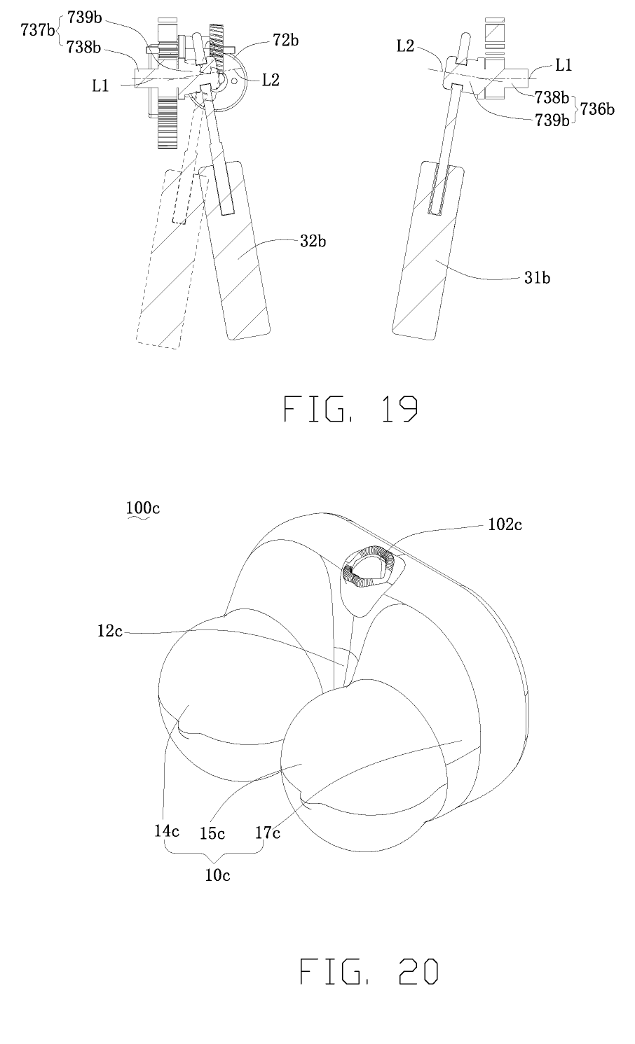

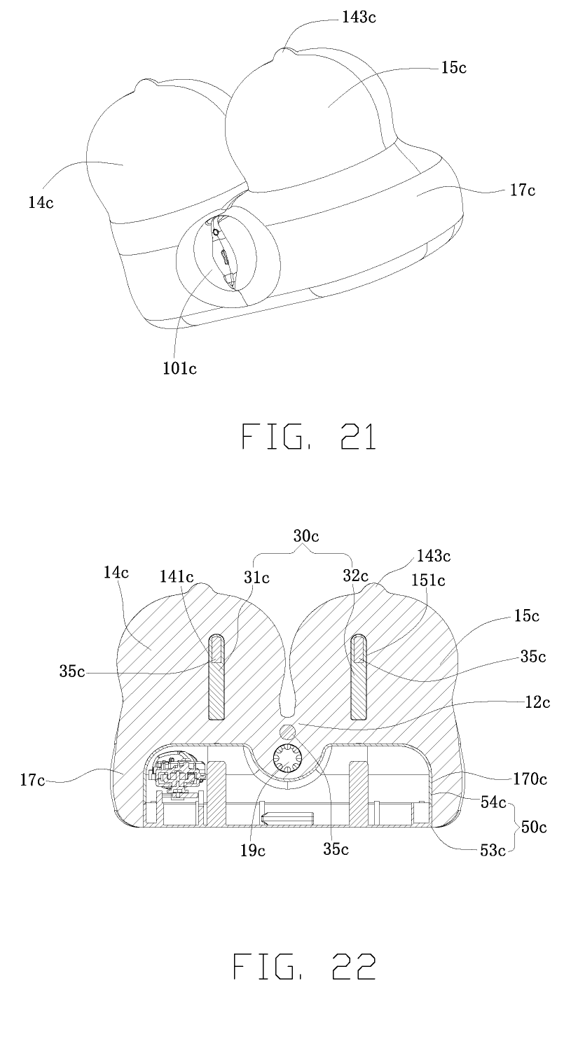

In a fourth embodiment of the present disclosure, as shown in FIGS. 20 to 22, a sexual stimulation device 100c is provided. The sexual stimulation device includes a shell 10c and a massaging portion 30c. The shell 10 defines a massaging space 12c for accommodating a male penis or other human body to be massaged. The shell 10c is made of a flexible material. The massaging portion 30c includes a first moving portion 31c and a second moving portion 32b located on two sides of the massaging space 12c respectively. The first moving portion 31c and the second moving portion 32c are opposite and spaced apart from each other in a first direction A. The shell 10c covers outer sides the first moving portion 31c and the second moving portion 32c. At least one of the first moving portion 31c and the second moving portion 32c is movably arranged so as to cause the shell 10b to deform, thereby massaging the human body to be massaged located in the massaging space 12c.

When the sexual stimulation device 100c of this embodiment is in use, a male penis or other human body to be massaged may be inserted into the massaging space 12c, and the movement of the massaging portion 30c massages the human body to be massaged. The massaging portion 30c can massage a relatively large region covering the movement trajectory of the massaging portion 30c, and at least one side of the human body can be massaged by the shell 10c, achieving a better massage effect and providing a good user experience.

In some embodiments, the first moving portion 31c and the second moving portion 32c are swingable towards each other or away from each other to move closer to or away from each other in the first direction A, so as to perform left-right massage on the human body to be massaged located in the massaging space 12. The movement of the first moving portion 31c and/or the second moving portion 32c enables the shell 10c to perform squeezing massage on the human body to be massaged.

In some embodiments, the shell 10c, as a component of the sexual stimulation device 100c that directly acts on the human body, can be made of soft materials such as silicone or rubber, and has a certain flexibility.

In some embodiments, the shell 10c includes a first contacting portion 14c and a second contacting portion 15c. The first contacting portion 14c and the second contacting portion 15c are spaced apart and opposite to each other. The massaging space 12c is defined at a region between the first contacting portion 14c and the second contacting portion 15c. Specifically, a first accommodating cavity 141c and a second accommodating cavity 151c are defined in the first contacting portion 14c and the second contacting portion 15c respectively. The first moving portion 31c and the second moving portion 32c are disposed in the first accommodating cavity 141b of the first contacting portion 14c and the second accommodating cavity 151c of the second contacting portion 15c respectively, so that the first contacting portion 14c and the second contacting portion 15c deform with the movement of the first moving portion 31c and the second moving portion 32c to form a massage action. Specifically, the massaging space 12c is a gap between the first contacting portion 14c and the second contacting portion 15c.

Specifically, the first contacting portion 14c and the second contacting portion 15c may be substantially frustoconical to simulate female breasts, i.e., the first contacting portion 14c and the second contacting portion 15c may be designed to be female breast-shaped. More specifically, in this embodiment, a top of each of the first contacting portion 14c and the second contacting portion 15c forms a protrusion 143c resembling a female nipple. It should be understood that the first contacting portion 14c and the second contacting portion 15c may also be cylindrical, spherical, or other shapes, which are not limited herein.

Specifically, a vibration member 35c may be provided in at least one of the first moving portion 31c and the second moving portion 32c. The vibration member 35c may be a vibration motor or a vibration actuator. Alternatively, a retractable member (such as a linear motor) may be provided in at least one of the first contacting portion 14c and the second contacting portion 15c.

Specifically, the shell 10c further includes a base portion 17c. The first contacting portion 14c and the second contacting portion 15c protrude from a top of the base portion 17c. A cavity 170c communicating with the first accommodating cavity 141c and the second accommodating cavity 151c is formed in the base portion 17c. Specifically, an opening 171c communicating with the cavity 170c is provided at a bottom of the base portion 17c.

In some embodiments, a massaging cavity 19c is further provided on the shell 10c, and a first massage end 101c and a second massage end 102c communicating with the massaging cavity 19c are formed on an outer surface of the shell 10c. The first massage end 101c and the second massage end 102c are located at two ends of the massaging cavity 19c respectively. The first massage end 101c may be in the shape of a labia, and the second massage end 102c may be in the shape of a mouth. It should be understood that the first massage end 101c and the second massage end 102c may also be in other shapes, such as an anus. The male penis may also be inserted into the massaging cavity 19c through the first massage end 101c or the second massage end 102c for massage. Specifically, in this embodiment, another vibration member 35c is provided adjacent to the massaging cavity 19c to generate a vibrating effect and massage the human body to be massaged located in the massaging cavity 19c. The massaging cavity 19c enables more diverse massage manners, thereby enhancing the massage experience. Alternatively, a retractable member (such as a linear motor) may be provided adjacent to the massaging cavity 19c.

Specifically, the massaging cavity 19c may be formed in the base portion 17c. Further, the massaging cavity 19c may extend along a direction perpendicular to the first direction. Specifically, the massaging cavity 19c is defined below the massaging space 12c.

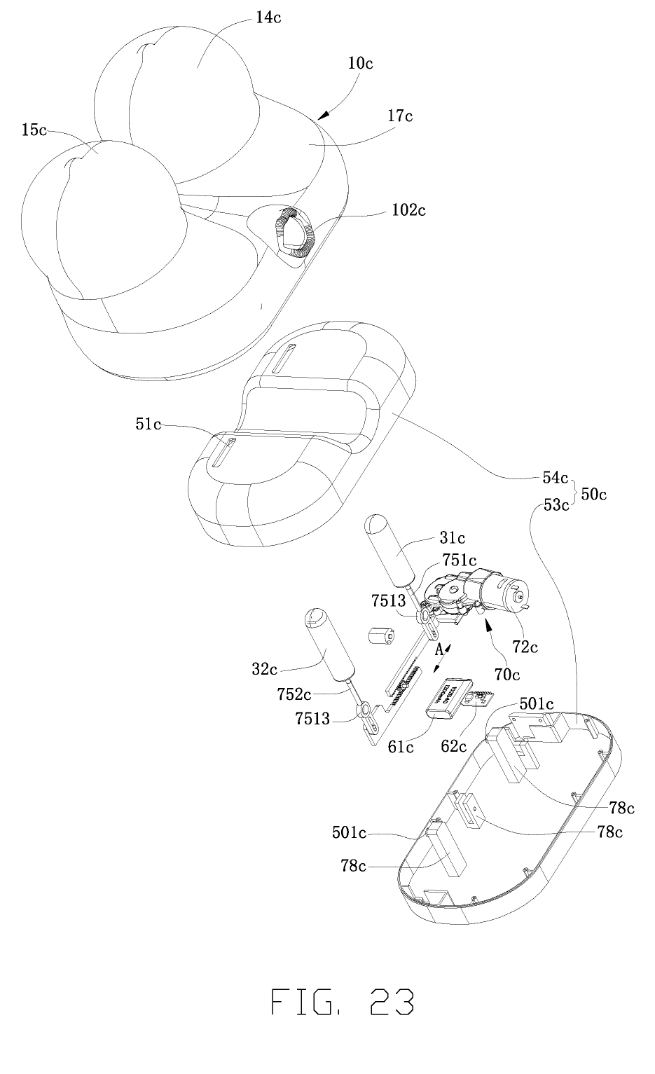

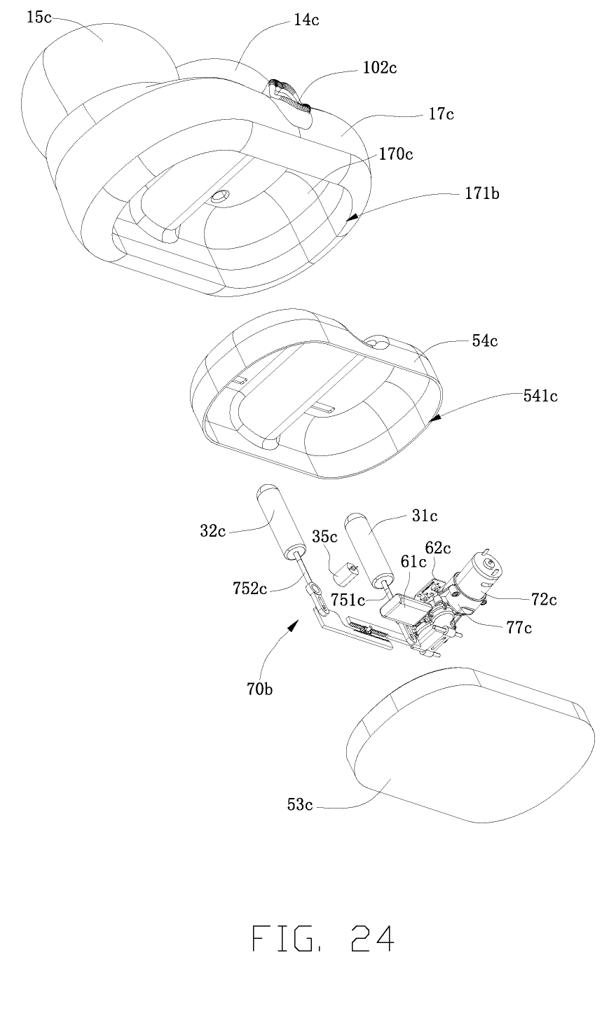

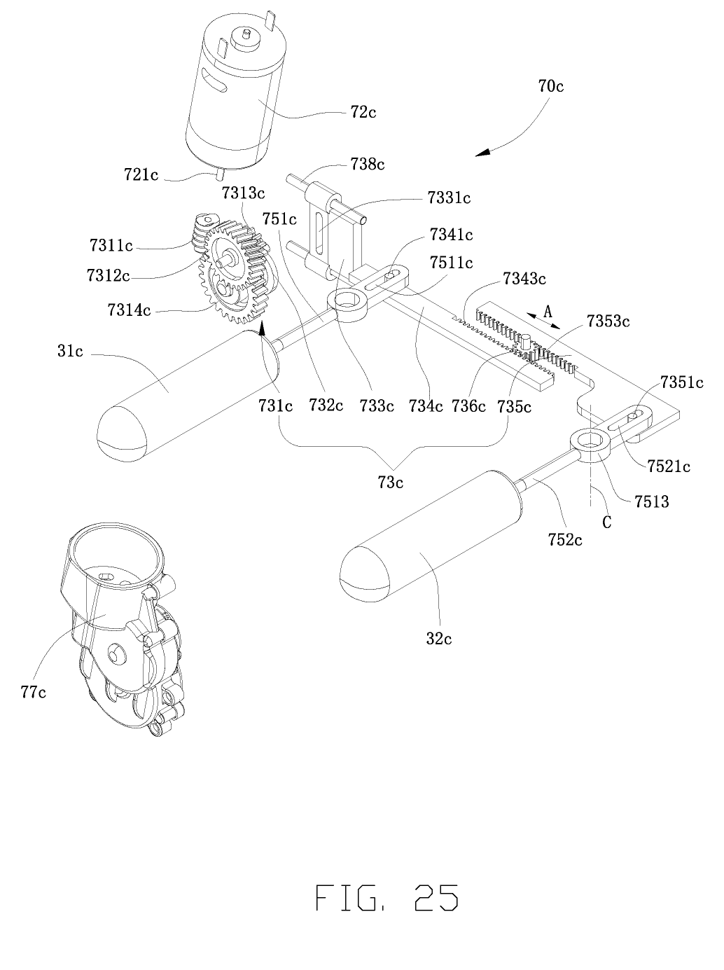

In some embodiments, referring also to FIGS. 23 and 24, the sexual stimulation device 100c further includes an inner shell 50c. The inner shell 50c is a rigid inner shell, and the base portion 17c of the shell 10c covers an outer side of the inner shell 50c. The inner shell 50c is disposed in the cavity 170c of the base portion 17c. The inner shell 50c is configured to support internal components. Specifically, the inner shell 50c is a hollow shell to accommodate internal components. Two ports 51c are provided at a top of the inner shell 50c. A part of the first moving portion 31c and a part of the second moving portion 32c pass through the two ports 51c from the inner shell 50c into the first contacting portion 14c and the second contacting portion 15c. The inner shell 50c is installed into the shell 10c from the opening 171c of the base portion 17c.

Specifically, the inner shell 50c includes a bottom shell 53c and a top shell 54c interlocked with each other. A bottom of the top shell 54c is open to form an aperture 541c, and the bottom shell 53c is disposed at the aperture 541c.

In some embodiments, a battery 61c and a circuit board 62c may be disposed in the inner shell 50c. The battery 61c may supply power to the vibration members 35c and a first driving mechanism 70c described below. The circuit board 62c may control the operation of the vibration member 35c and the first driving mechanism 70c according to user instructions.

In some embodiments, the sexual stimulation device 100c further includes a first driving mechanism 70c. The first driving mechanism 70c is connected to at least one of the first moving portion 31c and the second moving portion 32c and drives the first moving portion 31c and/or the second moving portion 32c to swing towards each other or away from each other. Specifically, the first driving mechanism 70c is disposed in the inner shell 50c.

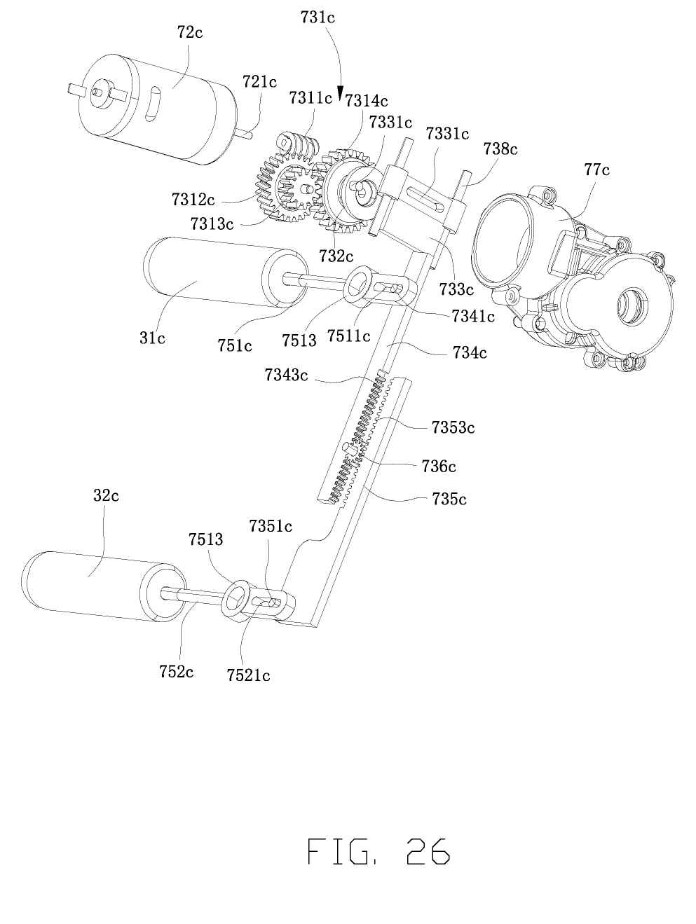

In some embodiments, referring to FIG. 25 and FIG. 26, the first driving mechanism 70c includes a first driving member 72c, a first transmission mechanism 73c, a first swing rod 751c, and a second swing rod 752c. The first transmission mechanism 73c is connected to the first driving member 72c, the first swing rod 751c, and the second swing rod 752c. The first driving member 72c is configured to drive, through the first transmission mechanism 73c, at least one of the first swing rod 751c and the second swing rod 752c to swing in a plane in which the first direction A lies. The first moving portion 31c and the second moving portion 32c are connected to the first swing rod 751c and the second swing rod 752c respectively so as to be driven thereby to move closer to or away from each other. Specifically, in this embodiment, the first driving mechanism 70c drives both the first moving portion 31c and the second moving portion 32c to move. It should be understood that in other embodiments, only one of the first moving portion 31c and the second moving portion 32c may be driven to move. In the embodiment shown in the figures, the first moving portion 31c and the second moving portion 32c are driven by the same driving member. It should be understood that in other embodiments, the first moving portion 31c and the second moving portion 32c may also be driven by two driving members respectively. The first driving member 72c may be a motor.

In some embodiments, the first transmission mechanism 73c includes a first gear group 731c, a rotating plate 732c, a slider 733c, a first linkage rod 734c, a second linkage rod 735c, and a reversing member 736c. An input end of the first gear group 731c is connected to an output shaft 721c of the first driving member 72c to be driven to rotate by the first driving member 72c. An output end of the first gear group 731c is connected to the rotating plate 732c. An eccentric post 7321c is eccentrically disposed on the rotating plate 732c, and the eccentric post 7321c is movably inserted into a first sliding slot 7331c of the slider 733c. The eccentric post 7321c rotates with the rotating plate 732c to drive the slider 733c to perform a reciprocating movement along the first direction A. The first linkage rod 734c is fixedly connected to the slider 733c. The second linkage rod 735c is connected to the first linkage rod 734c through the reversing member 736c so as to drive the second linkage rod 735c to perform a reciprocating movement along the first direction A. During moving, the first linkage rod 734c and the second linkage rod 735c move toward opposite direction. The first swing rod 751c and the second swing rod 752c are rotatably disposed around a third direction C, and the third direction C is perpendicular to both the first direction A and an extension direction of the first swing rod 751c. The first swing rod 751c defines a second sliding slot 7511c, and the first linkage rod 734c is provided with a first sliding post 7341c. The second swing rod 752c defines a third sliding slot 7521c, and the second linkage rod 735c is provided with a second sliding post 7351c. The first sliding post 7341c is movably inserted into the second sliding slot 7511c, and the second sliding post 7351c is movably inserted into the third sliding slot 7521c. Thus, the reciprocating movement of the first linkage rod 734c and the second linkage rod 735c can drive the first swing rod 751c and the second swing rod 752c to rotate within a certain range, achieving reciprocating swinging. It should be understood that in other embodiments, the second linkage rod 735c and the reversing member 736c may be omitted, and in this case, the second moving portion 32c is immovable, and only the first moving portion 31c is movable.

Specifically, the slider 733c is slidably sleeved over at least one slide rail 738c extending along the first direction A. In the embodiment shown in the figures, there are two slide rails 738c spaced apart from each other. Each of the first swing rod 751c and the second swing rod 752c includes a ring 7513 rotatably sleeved over a rotating shaft 501c provided on the inner shell 50c, so that the first swing rod 751c and the second swing rod 752c are rotatable relative to the inner shell 50c. Specifically, the first linkage rod 734c is provided with a first rack 7343c, and the second linkage rod 735c is provided with a second rack 7353c. The reversing member 736c is a gear meshing with the first rack 7343c and the second rack 7353c, and the reversing member 736c is located between the first rack 7343c and the second rack 7353c.

Specifically, the first gear group 731c includes a worm 7311c, a worm wheel 7312c meshing with the worm 7311c, a first gear 7313c coaxially disposed with the worm wheel 7312c, and a second gear 7314c meshing with the first gear 7313c. The second gear 7314c and the rotating plate 732c are coaxially disposed.

In this embodiment, the first driving mechanism 70c further includes a mounting seat 77c and a mounting frame 78c disposed in the inner shell 50c. The first driving member 72c is installed on the mounting seat 77c. The mounting seat 77c supports components such as the worm 7311c, the worm wheel 7312c, and the first gear 7313c. The mounting frame 78c supports components such as the slide rails 738c, the first linkage rod 734c, the second linkage rod 735c, and the reversing member 736c. The rotating shaft 501c is connected to the mounting frame 78c.

It should be understood that the sexual stimulation device 100c may further include a bracket assembly connected to a bottom of the inner shell 50c to support the sexual stimulation device 100c. The bracket assembly may have a structure the same as a structure of the bracket assembly 60 of the first embodiment.

### Fifth Embodiment

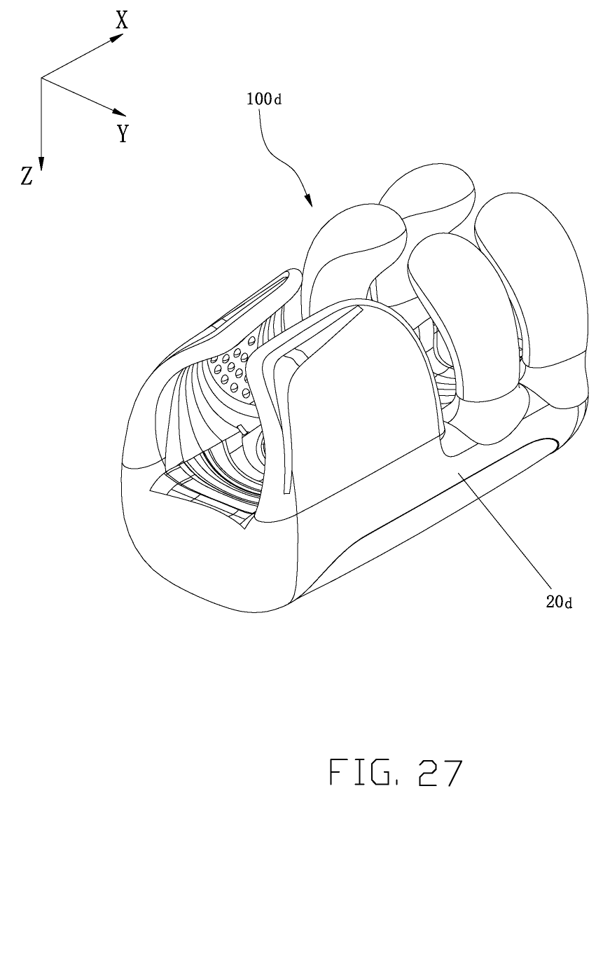

Referring to FIG. 27 to FIG. 32, a sexual stimulation device 100d according a fifth embodiment of the present disclosure is shown. The sexual stimulation device 100 includes a shell 20d and a stimulation assembly mounted in the shell 20d.

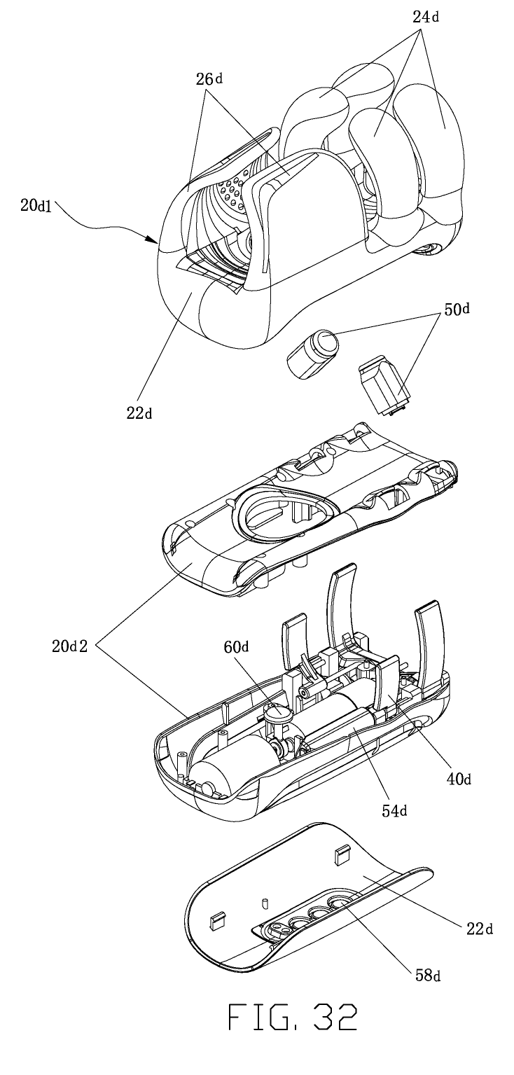

As shown in FIG. 27 and FIG. 32, the shell 20d in whole is configured as a human hand, which includes a main portion 22d configured as a palm and several swinging portion 24d extending from two opposite sides of the main portion 22d, respectively. The swinging portions 24d each are elongated, curved, and column-shaped, being configured as a finger. Further, two fixed portions 26d extend from two opposite sides of the main portion 22d, respectively. The fixed portions 26d each are configured as a curved sheet, and arranged in a row with the swinging portions 24d at a same lateral side of the main portion 22d.

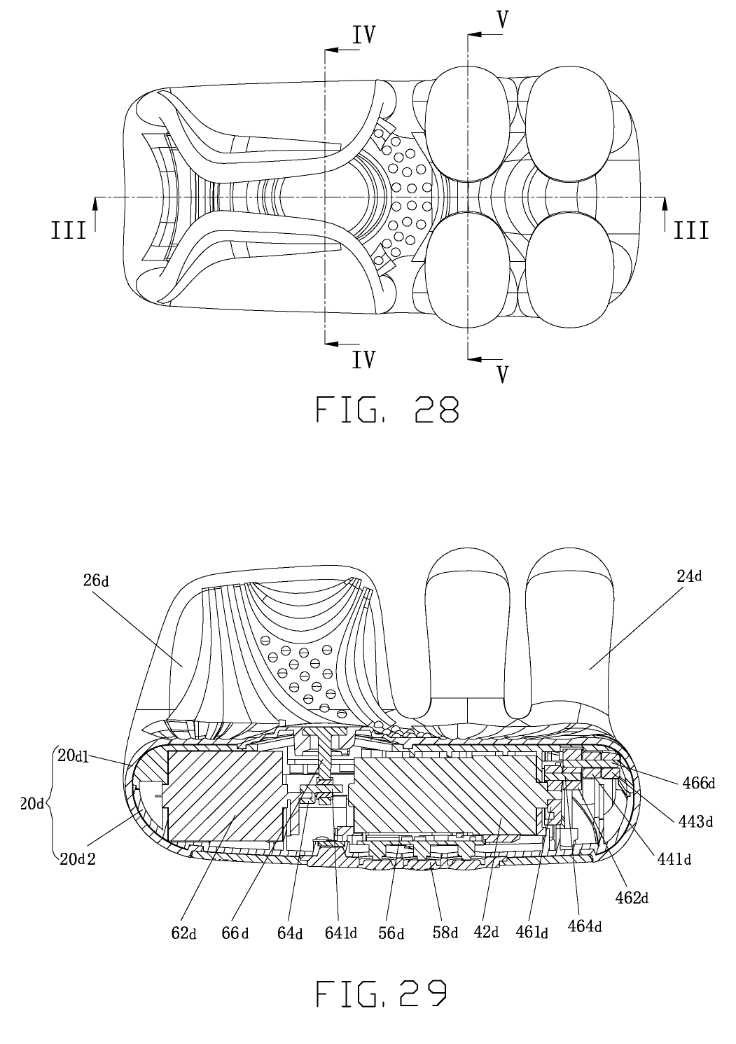

Referring also to FIG. 31, the swinging portions 24d of the shell 20d cooperatively define a first inner chamber 241d thereamong. Referring also to FIG. 28, the fixed portions 26d of the shell 20d cooperatively define a second inner chamber 261d therebetween. The first inner chamber 241d and second inner chamber 261d communicate with each other and cooperatively define an accommodating space, which is generally column-shaped and configured for receiving a sensitive part of the human body, such as a male genitalia therein.

As shown in FIG. 29 to FIG. 32, the shell 20d is a double-layer structure, and includes an outer shell 20d1 and an inner shell 20b inside the outer shell 20d1. The inner shell 20d2 may be made of hard materials, such as plastic, metal and etc., providing support to the stimulation assembly mounted inside the shell 20d; and the outer shell 20d1 may be made of soft materials, such as silicone, rubber and etc., for directly contacting the male genitalia, thereby the male sexual stimulation device 100d in whole has high strength and comfortable use experience.

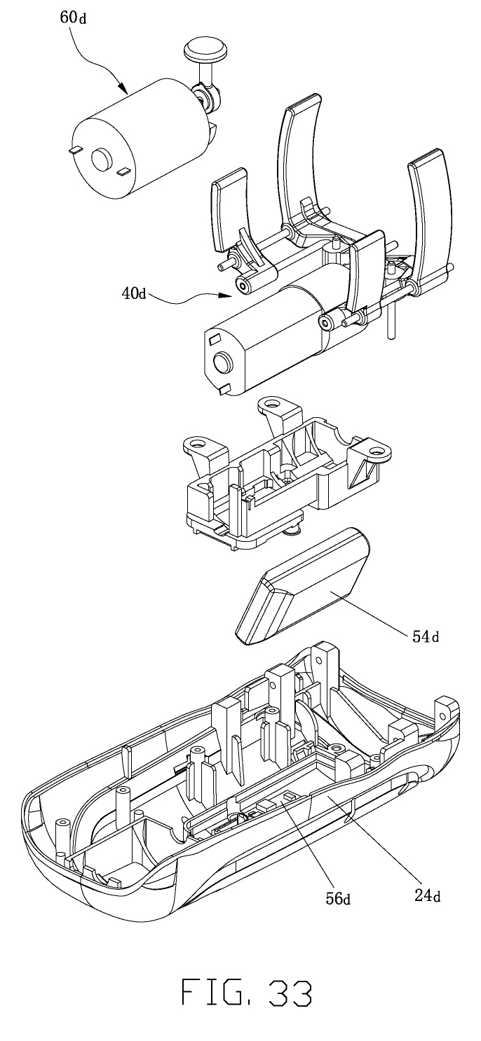

Referring to FIG. 32 and FIG. 33, the stimulation assembly of this embodiment includes a first stimulation module 40d and a second stimulation module 60d.

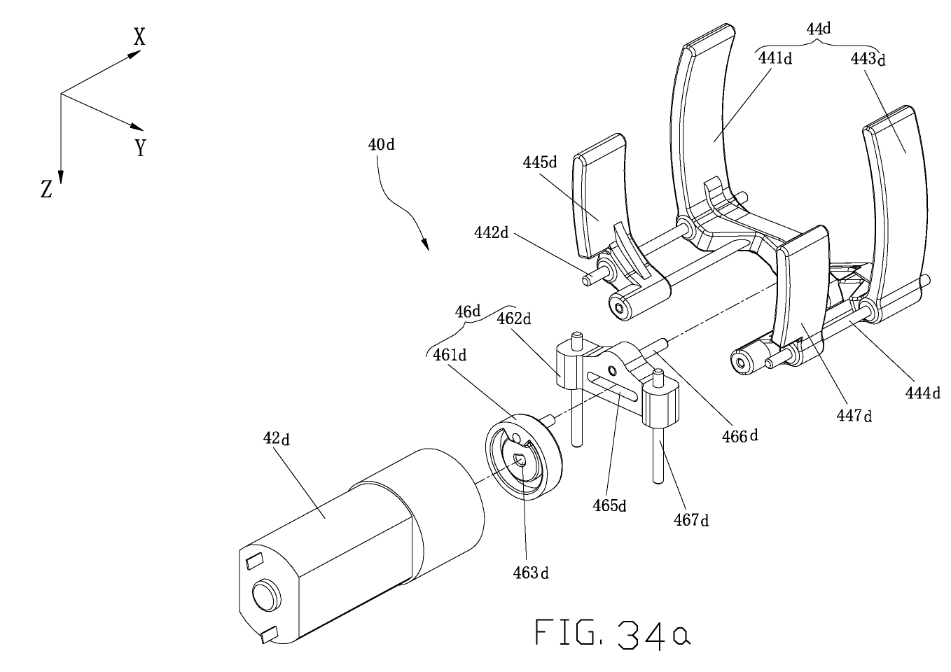

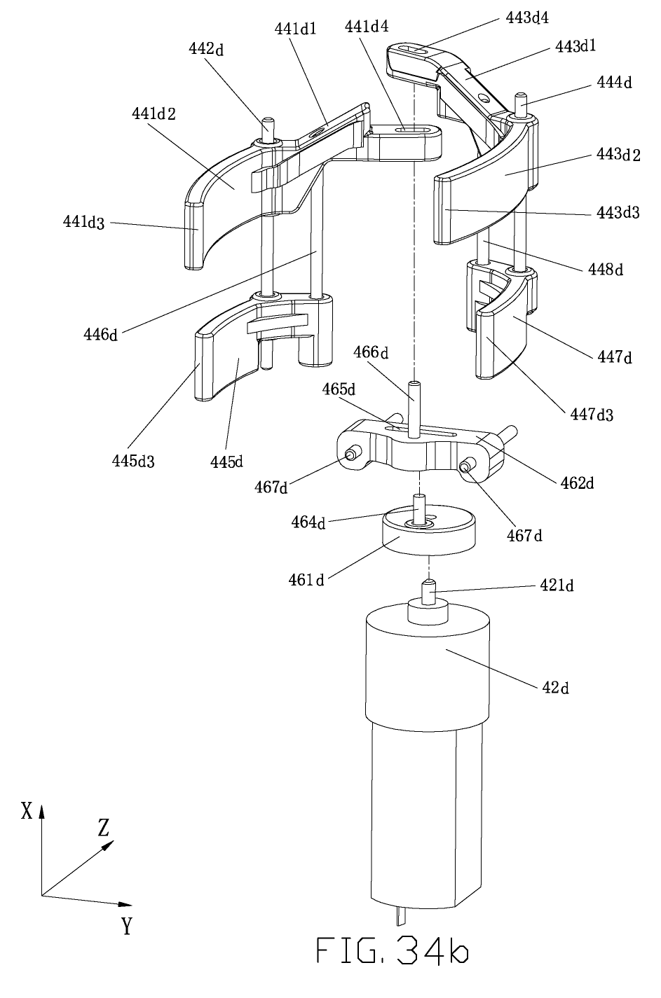

As shown in FIGS. 34a and 34b, the first stimulation module 40d includes a first motor 42d, a swinging unit 44d and a transmission unit 46d connected between the first motor 42d and the swinging unit 44d. The swinging unit 44d includes a first swinging bar 441d and a second swinging bar 443d which are substantially arranged symmetric to each other. During operation of the first motor 42d, the first swinging bar 441d and second swinging bar 443d are driven to swing relative to the shell 20d, close to or away from each other, thereby achieving an occlusion action to occlude the male genitalia inside the accommodating space.

The first swinging bar 441d includes a first connecting arm 441d1 and a first swinging arm 441d2 which are connected to each other. Preferably, the first connecting arm 441d1 and the first swinging arm 441d2 are integrally formed as one piece, and an included angle is set therebetween. A joint portion of the first connecting arm 441d1 and the first swinging arm 441d2 is rotatably connected to the inner shell 20d2 by a first pivot 442d. A distal end of the first connecting arm 441d1 away from the first swinging arm 441d2 is connected to the transmission unit 46d, and a distal end of the first swinging arm 441d2 away from the first connecting arm 441d1 is configured as a first swinging end 441d3 and extends into one of the swinging portions 24d at a first lateral side (such as a left side in FIG. 34a) of the shell 20d.

Similarly, the second swinging bar 443d includes a second connecting arm 443d1 and a second swinging arm 443d2 which are connected to each other and angled with each other. A joint portion of the second connecting arm 443d1 and the second swinging arm 443d2 is rotatably connected to the inner shell 20d2 by a second pivot 444d. A distal end of the second connecting arm 443d1 away from the second swinging arm 443d2 is connected to the transmission unit 46d, and a distal end of the second swinging arm 443d2 away from the second connecting arm 443d1 is configured as a second swinging end 443d3 and extends into one of the swinging portions 24d at a second lateral side (such as a right side in FIG. 34a) of the shell 20d.

The distal ends of the first and second connecting arms 441d1, 443d1 can be driven to move along a first direction, such as Z-direction, and thus the first and second swinging arms 441d2, 443d2 can swing about the first pivot 442d and second pivot 444d, respectively.

The first pivot 442d and second pivot 444d both extend along a second direction, such as X-direction, being parallel to and spaced from each other. The first swinging end 441d3 and the second swinging end 443d3 are opposite to each other in a third direction, such as Y-direction. During operation, the first motor 42d drives the distal ends of the first connecting arm 441d1 and the second connecting arm 443d1 to do reciprocating movement synchronously in the Z-direction through the transmission unit 46d, making the first swinging bar 441d swing about the first pivot 442d and the second swinging bar 443d swing about the second pivot 444d in opposite directions, thereby the first swinging end 441d3 and second swinging end 443d3 swinging towards or away from each other to achieve the occlusion action.

In this embodiment, the swinging unit 44d further includes a third swinging bar 445d and a fourth swinging bar 447d which are arranged substantially symmetric to each other. The first pivot 442d extends through a middle portion of the third swinging bar 445d to rotatably connect the third swinging bar 445d to the inner shell 20b, and the second pivot 444d extends through a middle portion of the fourth swinging bar 447d to rotatably connect the fourth swinging bar 447d to the inner shell 20d2. The first pivot 442d may be fixed to the first and third swinging bars 441d, 445d to rotate along therewith, or, may be fixed to the inner shell 20d2; and the second pivot 444d may be fixed to the second and fourth swinging bars 443d, 447d to rotate along therewith, or, may be fixed to the inner shell 20d2.

The third swinging bar 445d has one end configured as a third swinging end 445d3 and extends into another one of the swinging portions 24d at the first lateral side of the shell 20d, and another end being fixedly connected to the first connecting arm 441d1 of the first swinging bar 441d by a third pivot 446d, thereby the third swinging bar 445d can swing about the first pivot 442d together with the first swinging bar 441d; and the fourth swinging bar 447d has one end configured as a fourth swinging end 447d3 and extends into another one of the swinging portions 24d at the second lateral side of the shell 20d, and another end being fixedly connected to the second connecting arm 443d1 of the second swinging bar 443d by a fourth pivot 448d, thereby the fourth swinging bar 447d can swing about the second pivot 444d together with the second swinging bar 443d. The third swinging end 445d3 and the fourth swinging end 447d3 are opposite to each other in the Y-direction, which can swing towards or away from each other to achieve an occlusion action.

In this embodiment, corresponding to the first to fourth swinging ends 441d3, 442d3, 445d3, 447d3 of the first to fourth swinging bars 441d, 443d, 445d, 447d of the swinging unit 44d of the first stimulation module 40d, the shell 20d, specifically the outer shell 20d1, is provided with four swinging portions 24d which accommodate the four swinging ends 441d3, 442d3, 445d3, 447d3 therein, respectively. During operation, the swinging portions 24d swing together with the swinging ends 441d3, 442d3, 445d3, 447d3 to occlude the male genitalia in the accommodating space. Such male sexual stimulation device can simulate a human hand to hold and pinch the male genitalia, which can better stimulate users.

It should be understood that a number of the swinging bars of the swinging unit is preferably multiple, such as two, three, four, six, eight, etc., which should not be limited to specific embodiments; and, a number of the swinging portions of the shell may be designed the same as that of the swinging bars, thereby accommodating and swinging together with the swinging ends of the swinging bars, respectively.

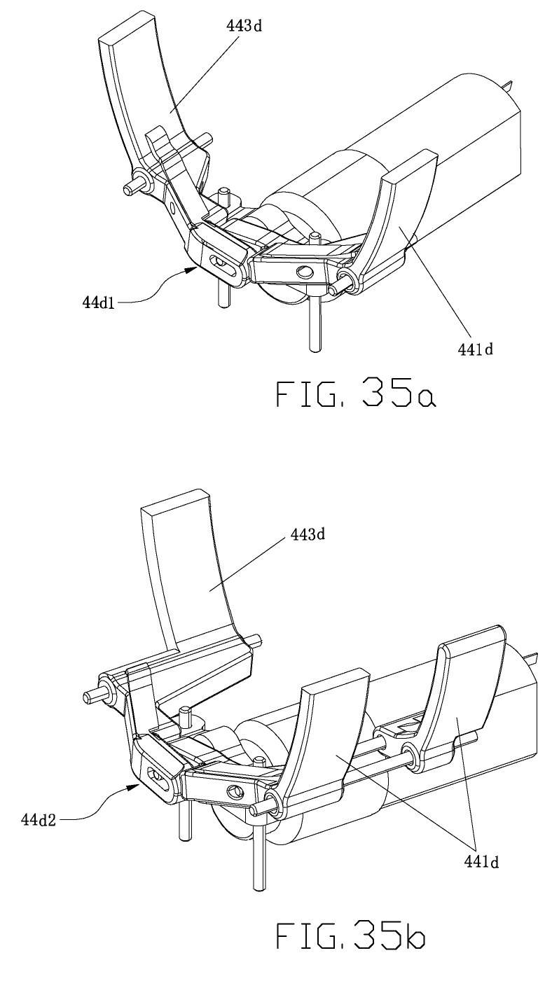

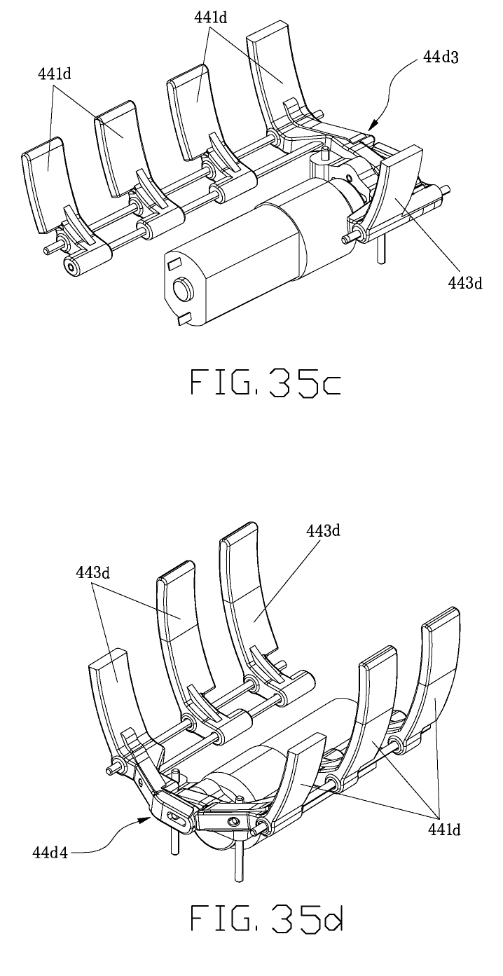

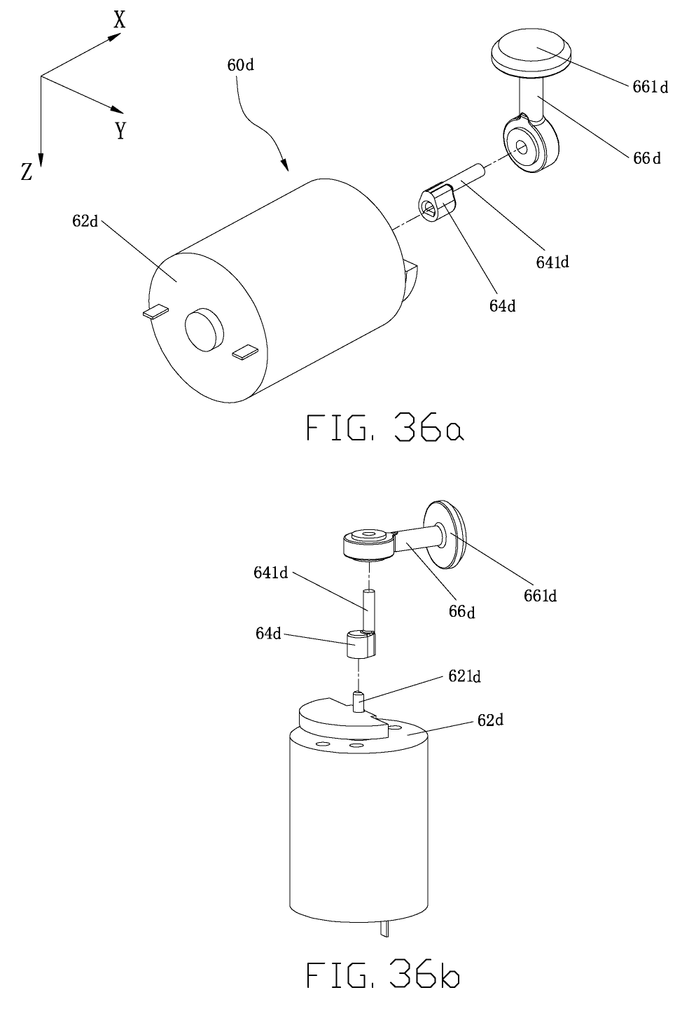

FIG. 35a to FIG. 35d show alternative embodiments of the swinging unit. FIG. 33a shows a swinging unit 44a with a first swinging bar 441d and a second swinging bar 443d, wherein the two swinging bars 441d, 443d are arranged substantially symmetric to each other in the Y-direction. FIG. 33b shows a swinging unit 44d2 with three swinging bars 441d, 443d being staggered in the X-direction, wherein two first swinging bars 441d are located at the same lateral side, and one second swinging bar 443d is located at an opposite lateral side. FIG. 33c shows a swinging unit 44d3 with five swinging bars 441d, 443d, wherein four first swinging bars 441d are located at the same lateral side, and one second swinging bas 443d is located at an opposite lateral side. FIG. 33d shows a swinging unit 44d with six swinging bars 441d, 443d, wherein one lateral side is provided with three first swinging bars 441d and an opposite lateral side is provided with three second swinging bars 443d.

Referring to FIG. 34a and FIG. 34b, in this embodiment, the first motor 42d is a rotary motor, and has a rotary shaft 421d for outputting torque. The transmission unit 46d is configured for converting rotation of the first motor 42d into reciprocating movement along the first direction, thereby driving the distal ends of the first and second connecting arms 441d1, 443d1 to move in the first direction. The transmission unit 46d includes a first eccentric wheel 461d and a sliding block 462d.

The first eccentric wheel 461d is connected to the rotary shaft 421d of the first motor 42d. In this embodiment, the first eccentric wheel 461d is generally circular-shaped, and a central hole 463d is defined in a central portion thereof for inserting of the rotary shaft 421d therein. The central hole 463d of the first eccentric wheel 461d is non-circular shaped, such as D-shaped, and a cross section of the rotary shaft 421d has a shape matching with that of the central hole 463d. After inserting of the rotary shaft 421d into the central hole 463d of the first eccentric wheel 461d, a relative rotation therebetween is limited for shape matching, thereby the first eccentric wheel 461d can rotate along with the rotary shaft 421d of the first motor 42d.

A first rod 464d extends outwardly from a periphery of the first eccentric wheel 461d, that is, the first rod 464d is set eccentrically on the first eccentric wheel 461d. Generally, the first rod 464d is parallel to the rotary shaft 421d of the first motor 42d. During rotation of the first eccentric wheel 461d along with the rotary shaft 421d of the first motor 42d, the first rod 464d revolves round the rotary shaft 421d. In this embodiment, the rotary shaft 421d extends along the X-direction, and the first rod 464d revolves round the rotary shaft 421d in YZ plane. In other words, the first rod 464d generates displacements on both the Y-direction and the Z-direction under the driving of the first motor 42d.

The sliding block 462d defines a sliding groove 465d therein, which is strip-shaped and elongated in the Y-direction. The first rod 464d engages into the sliding groove 465d, and is fixed relative to the sliding block 462d in the Z-direction whilst is slidable relative to the sliding block 462d in the Y-direction. During revolving of the first rod 464d round the rotary shaft 421d, its displacement in the Y-direction cannot drive the sliding block 462d to move, while its displacement in the Z-direction drives the sliding block 462d to do reciprocating movement. Thereby, rotation of the first motor 42d is converted into reciprocating liner motion of the sliding block 462d in the Z-direction.

In this embodiment, the distal end of the first connecting arm 441a defines a first slot 441d4 therein, and the distal end of the second connecting arm 443d1 defines a second slot 443d4 therein. A second rod 466d extends outwardly from the sliding block 462d along the X-direction, and is movably engaged into the first slot 441d4 and the second slot 443d4, thereby the sliding block 462d can drive the distal ends of the first and second connecting arms 441d1, 443d1 to do reciprocating movement synchronously in the Z-direction. The first and second slots 441d4, 443d4 may be strip-shaped in an extension direction of the first and second connecting arms 441d1, 443d1, thereby the second rod 466d having more movement allowance in the first and second slots 441d4, 443d4.

In this embodiment, the sliding block 462d is movably connected to the inner shell 20d2 by a fifth pivot 467d which extends along the Z-direction. The fifth pivot 467d movably extends through the sliding block 462d, thereby guiding movement of the sliding block 462d in the Z-direction. Preferably, each end of the sliding block 462d in the Y-direction is provided with one fifth pivot 467d, thus a movement of the sliding block 462d in the Z-direction can be more stable, and accordingly swinging of the swinging ends 441d3, 442d3, 445d3, 447d3 of the swinging unit 44d driven by the second rod 466d of the sliding block 462d can be more consistent and powerful. That is to say, the stimulation intensity of each swinging portion 24d of the male sexual stimulation device 100d is more consistent and the overall stimulation effect is better.

As shown in FIG. 31and FIG. 32, the stimulation assembly further includes at least one second motor 50d, such as a vibration motor. The second motor 50d is set in the swinging portions 24d of the shell 20d, and located adjacent to distal ends of the swinging portions 24d. The second motor 50d is configured for generating high-frequency vibration to the male genitalia in the accommodating space. Preferably, there are several second motors 50d, and each second motor 50d is set in one of the swinging portions 24d. During in use, the first stimulation module 40d or the vibration motor 50d may be started separately, or the first stimulation module 40d and vibration motor 50d may be started at the same time.

As shown in FIG. 36a and FIG. 36b, the second stimulation module 60d includes a third motor 62d with a rotary shaft 621d, a third eccentric wheel 64d connected to the rotary shaft 621d of the third motor 62d, and a swinging rod 66d connected to the third eccentric wheel 64d. The third eccentric wheel 64d has a third rod 641d extending out therefrom, and the third rod 641d is parallel to the rotary shaft 621d of the third motor 62d. The swinging rod 66d is generally perpendicular to the third rod 641d, with one end thereof being rotatably mounted around the third rod 641d and another end thereof embedded into the main portion 22d of the shell 20d, specifically a part of the main portion 22d corresponding to second inner chamber 261d between the fixed portions 26d.

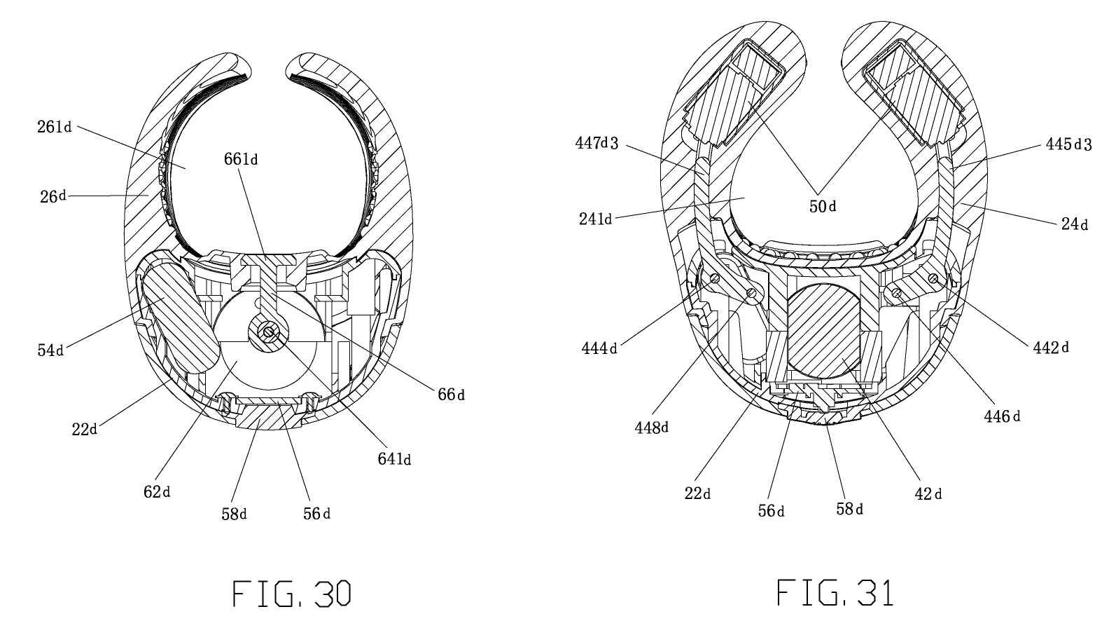

Preferably, a head 661d with a diameter larger than other portions of the swinging rod 66 is formed at the another end of the swinging rod 66d, improving a stability of the connection between the swinging rod 66d and the main portion 22d. Preferably, for facilitating the movement of the swinging rod 66d, the part of the main portion 22d corresponding to the head 661d of the swinging rod 66d is configured only with the soft outer shell 20d1, i.e., without the hard inner shell 20d2, as shown in FIG. 29 and FIG. 30.

Referring also to FIG. 29 and FIG. 30, the rotary shaft 621d of the third motor 62d and the third rod 641d of the third eccentric wheel 64d both extend along the X-direction, and the swinging rod 66d extends along the Z-direction. During operation, rotation of the third motor 62d is converted into revolving of the swinging rod 66d about the rotary shaft 621d, and then converted into reciprocating movement of the swinging rod 66d and the part of the main portion 22d adjacent to the head 661d of the swinging rod 66d in the Z-direction since the swinging rod 66d is limited to move in the X-direction and Y-direction for the engagement with the shell 20d. At the same time, a relative rotation is generated between the swinging rod 66d and the third rod 641d. That is, the second stimulation module 60d provides reciprocating motion in the Z-direction to drum the male genitalia in the accommodating space.

The first and second stimulation modules 40d, 60d provide stimulation to different parts of the male genitalia in different manners and thus can achieve better stimulation effects. It should be understood that the second stimulation module 60d may be started separately, or may be used with the first stimulation module 40d at the same time. For enhance user comfort, the swinging portions 24d of the shell 20d, which forms the first inner chamber 241d, the fixed portions, which forms the second inner chamber 261d, are configured only with the soft outer shell 20d1, i.e., without the hard inner shell 20d2.

Referring to FIG. 32 and FIG. 33 again, a battery 54d, preferably a rechargeable battery, is arranged in the main portion 22d of the shell 20d for supplying electric power to electric components, such as the first, second and third motors 42d, 50d, 62d, of the male sexual stimulation device 100d. Further, a control circuit board 56d is mounted in the shell 20d and electrically connected to the first, second and third motors 42d, 50d, 62d for controlling their operation according to user's instructions, such as controlling the vibration frequency of the second motor 50d, controlling the rotary speed of the first and third motors 42d, 62d, and etc. Control buttons 58d, such as mechanical buttons or touch buttons, may be provided on the outer shell 20d1 for input the user's instructions.

### Sixth Embodiment

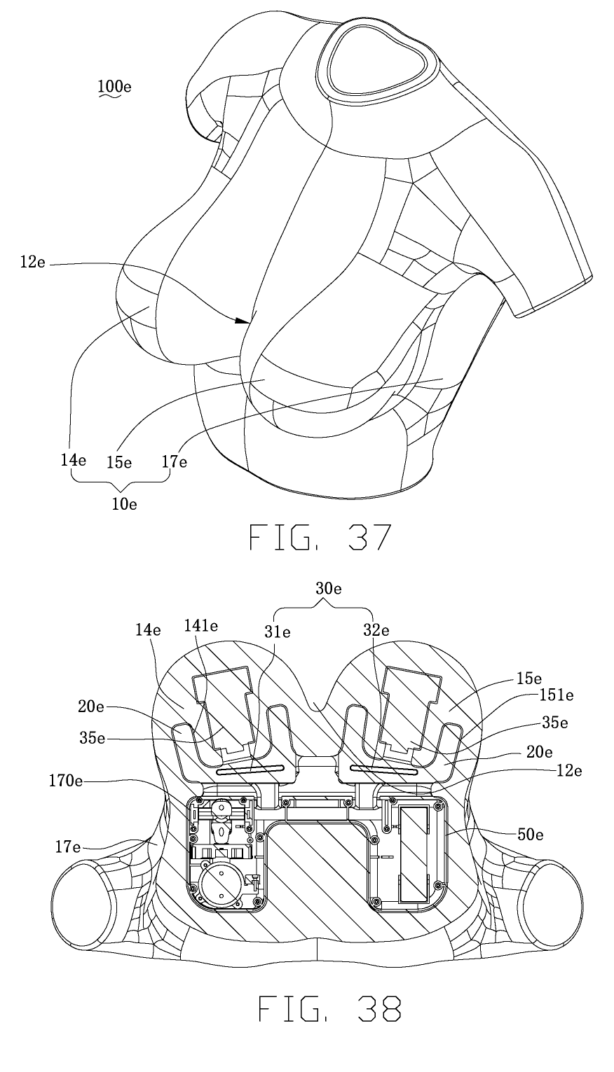

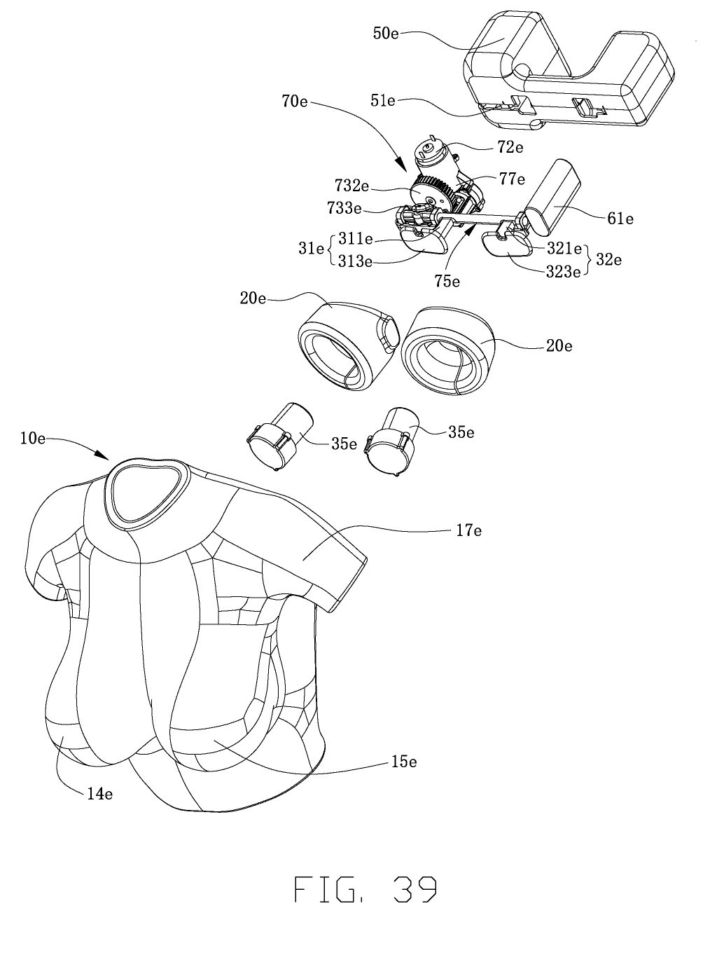

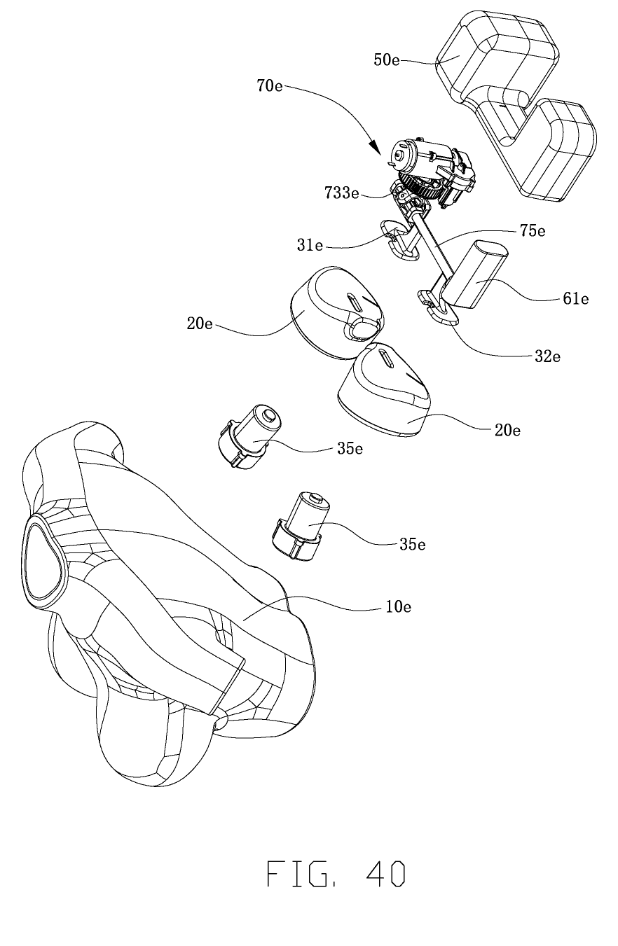

In a sixth embodiment of the present disclosure, as shown in FIG. 37 to 40, a sexual stimulation device 100e is provided. The sexual stimulation device 100e includes a shell 10e and a massaging portion 30e. The shell 10e defines a massaging space 12e for accommodating a male penis or other human body to be massaged. The shell 10e is made of a flexible material. The massaging portion 30e includes a first moving portion 31e and a second moving portion 32e located on two sides of the massaging space 12e respectively. The first moving portion 31e and the second moving portion 32e are opposite to each other and spaced apart from each other in a first direction A. The shell 10e covers outer sides of the first moving portion 31e and the second moving portion 32e. At least one of the first moving portion 31e and the second moving portion 32e is movably arranged so as to cause the shell 10e to deform, thereby massaging the human body to be massaged located in the massaging space 12e.

When the sexual stimulation device 100e of this embodiment is in use, a male penis or other human body to be massaged may be inserted into the massaging space 12e, and the movement of the massaging portion 30e massages the human body to be massaged. The massaging portion 30e can massage a relatively large region covering the movement trajectory of the massaging portion 30e, and at least one side of the human body can be massaged by the shell 10e, achieving a better massage effect and providing a good user experience.

In some embodiments, the at least one of the first moving portion 31e and the second moving portion 32e is swingable in a plane perpendicular to the first direction A, so as to perform back-and-forth massage on the human body located in the massaging space 12e, achieving a better massage effect and providing a good user experience.

In some embodiments, the first moving portion 31e and the second moving portion 32e are rotatable around the first direction A within a certain angular range (an angular range of less than 360 degrees) so as to perform reciprocating swing, thereby causing a position of at least one of the first moving portion 31e and the second moving portion 32e to vary in a second direction B (i.e., a front-rear direction) intersecting the first direction A. It should be understood that the first direction A and the second direction B are arranged at an angle. Specifically, in this embodiment, the angle between the first direction A and the second direction may be 90°.

In some embodiments, the shell 10e, as a component of the sexual stimulation device 100e that directly acts on the human body, may be made of soft materials such as silicone or rubber, and has a certain flexibility.

In some embodiments, the shell 10e includes a first contacting portion 14e and a second contacting portion 15e. The first contacting portion 14e and the second contacting portion 15e are spaced apart and opposite to each other. The massaging space 12e is defined at a region between the first contacting portion 14e and the second contacting portion 15e. Specifically, a first accommodating cavity 141e and a second accommodating cavity 151e are defined in the first contacting portion 14e and the second contacting portion 15e respectively. The first moving portion 31e and the second moving portion 32e are disposed in the first accommodating cavity 141e of the first contacting portion 14 and the second accommodating cavity 151e of the second contacting portion 15e respectively, so that the first contacting portion 14e and the second contacting portion 15e deform with the movement of the first moving portion 31e and the second moving portion 32e to form a massage action. Specifically, the massaging space 12e is a gap defined between the first contacting portion 14e and the second contacting portion 15e.

Specifically, the first contacting portion 14e and the second contacting portion 15e may be substantially frustoconical to simulate female breasts. The first contacting portion 14e and the second contacting portion 15e are designed to simulate the shape of human body, it can provide a better visual effect and tactile sensation, achieving a better sexual stimulation effect.

Specifically, a vibration member 35e may be provided in at least one of the first moving portion 31e and the second moving portion 32e. The vibration member 35e may be a vibration motor or a vibration actuator. Alternatively, a retractable member (such as a linear motor) may be provided in at least one of the first contacting portion 14e and the second contacting portion 15e.

Specifically, the first moving portion 31e includes a first connecting portion 311e and a first acting portion 313e connected to the first connecting portion 311e. The second moving portion 32e includes a second connecting portion 321e and a second acting portion 323e connected to the second connecting portion 321e. The first acting portion 313e and the second acting portion 323e are flat plates.

Specifically, the shell 10e further includes a base portion 17e. The first contacting portion 14e and the second contacting portion 15e protrude from the base portion 17e. A cavity 170e communicating with the first accommodating cavity 141e and the second accommodating cavity 151e is defined in the base portion 17e. Specifically, the base portion 17e may be designed in the shape of a female upper torso, that is, the base portion 17e may include an abdominal portion, a shoulder-neck portion, and the above-mentioned first contact portion 14e and second contact portion 15e.

In some embodiments, the sex stimulation device 100e further includes two flexible connecting housings 20e, and the flexible connecting housings 20e cover outer surfaces of the first moving portion 31e and the second first moving portion 32e. The flexible connecting housing 20e is received within the first accommodating cavity 141e of the first contacting portion 14e and the second accommodating cavity 151e of the second contacting portion 15e. The flexible connecting housing 20e has a hardness less than that of the first moving portion 31e and the second moving portion 32e and greater than that of the first contacting portion 14e and the second contacting portion 15e. The arrangement of the flexible connecting housing 20e enables flexible connection, thereby preventing overly stiff movements and enhancing massage comfort. Specifically, the flexible connecting housing 20e is substantially a hollow cylinder. The first acting portion 313e and the second acting portion 323e are inserted into two flexible connecting housings 20e respectively. It should be understood that flexible connecting housings 20e may also be provided in the above-described sexual stimulation device of the first embodiment, the above-described sexual stimulation device of the second embodiment, the above-described sexual stimulation device of the third embodiment, the above-described sexual stimulation device of the fourth embodiment and the above-described sexual stimulation device of the fifth embodiment.

In some embodiments, the sexual stimulation device 100e further includes an inner shell 50e. The inner shell 50e is a rigid inner shell, and the base portion 17e of the shell 10e covers an outer side of the inner shell 50e. The inner shell 50e is disposed in the cavity 170e of the base portion 17e. The inner shell 50e is configured to provide support for internal components. Specifically, the inner shell 50e is a hollow shell to accommodate internal components. Two ports 51e are provided at a top of the inner shell 50e. A part of the first moving portion 31e and a part of the second moving portion 32e pass through the two ports 51e from the inner shell 50e into the first contacting portion 14e and the second contacting portion 15e respectively.

In some embodiments, a battery 61e may be disposed in the inner shell 50e.

In this embodiment, the sexual stimulation device 100e further includes a first driving mechanism 70e. The first driving mechanism 70e may be disposed in the inner shell 50e. The first driving mechanism 70e is connected to the first moving portion 31e and the second moving portion 32e and drives the first moving portion 31e and the second moving portion 32e to move. In another embodiment, the first driving mechanism 70e may be connected to one of the first moving portion 31e and the second moving portion 32e and drives one of the first moving portion 31e and the second moving portion 32e to move.

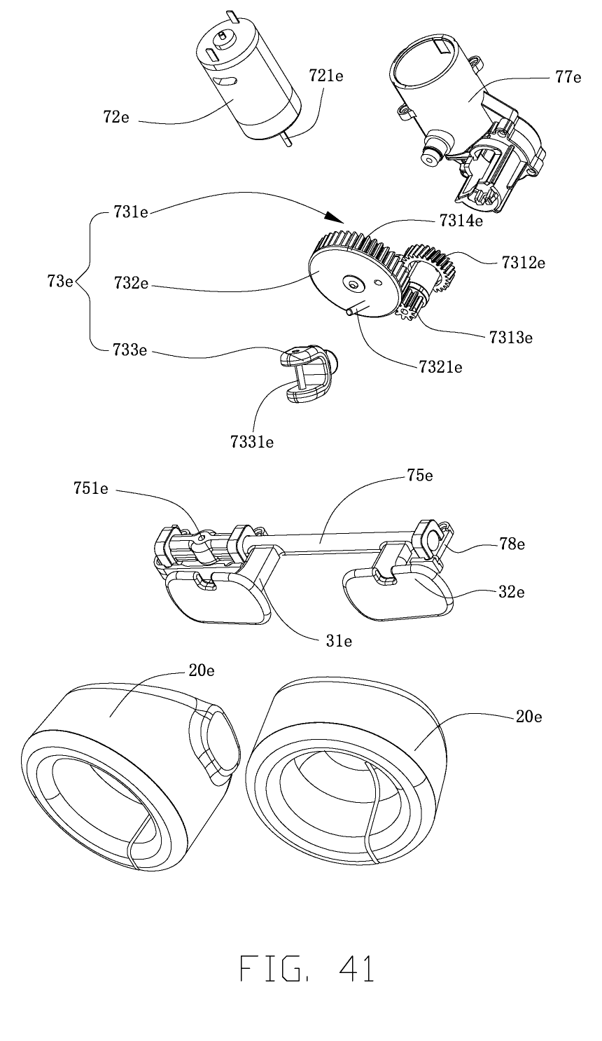

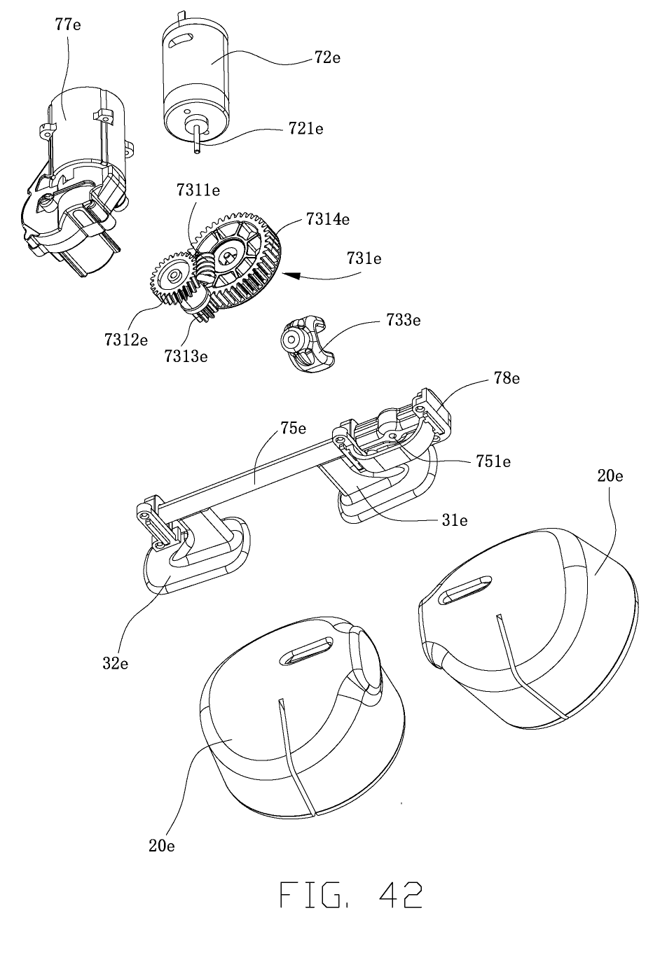

Specifically, referring also to FIG. 41 and FIG. 42, the first driving mechanism 70e includes a first driving member 72e, a first transmission mechanism 73e, and a sliding push rod 75e. The first transmission mechanism 73e is connected to the first driving member 72e and the sliding push rod 75e. The first driving member 72e is configured to drive the sliding push rod 75e to rotate around the first direction A through the first transmission mechanism 73e, so as to drive the siding push rod 75e perform reciprocating swing in a plane perpendicular to the first direction A. The first moving portion 31e and the second moving portion 32e are fixed to the sliding push rod 75e. The first driving member 72 may be a motor.

The first transmission mechanism 73e includes a gear group 731e, a rotating plate 732e, and a swinging block 733e. An input end of the gear group 731e is connected to an output shaft 721e of the first driving member 72e, and an output end of the gear group 731e is connected to the rotating plate 732e. The rotating plate 732e is provided with an eccentric post 7321e disposed eccentrically thereon. The eccentric post 7321e is connected to the swinging block 733e, and the swinging block 733e is connected to the sliding push rod 75e. As the rotating plate 732e rotates, the eccentric post 7321e drives the swinging block 733e and the sliding push rod 75e to pivot together about a first direction A by a predetermined angle, thereby causing a forward-and-backward swinging movement. Further, the swinging block 733e includes a rotating shaft 7331e, which is inserted into a shaft hole 751e of the sliding push rod 75e to effect connection therebetween.

Specifically, in this embodiment, the first moving portion 31e and the second moving portion 32e are arranged on the sliding push rod 75e and spaced apart from each other.

Specifically, in this embodiment, the gear group 731e includes a worm 7311e, a worm wheel 7312e meshing with the worm 7311e, a first gear 7313e coaxially arranged with the worm wheel 7312e, and a second gear 7314e meshing with the first gear 7313e. The worm 7311e is connected to the output shaft 721e of the first driving member 72e. The second gear 7314e is coaxially arranged with the rotating disk 732e; alternatively, the second gear 7314e may be disposed on the outer periphery of the rotating disk 732e.

In this embodiment, the first driving mechanism 70e further includes a mounting seat 77e and a mounting frame 78e installed on the inner shell 50e. The first driving member 72e is installed on the mounting seat 77e. The mounting seat 77e is configured to support components such as the worm 7311e, the worm wheel 7312e and the first gear 7313e. The mounting frame 78e is configured to support components such as the sliding pus rod 75d.

It should be understood that the bracket assembly 60 may also be provided in the above-described sexual stimulation device of the sixth embodiment, the above-described sexual stimulation device of the second embodiment, the above-described sexual stimulation device of the third embodiment, the above-described sexual stimulation device of the fourth embodiment and the above-described sexual stimulation device of the fifth embodiment. The second driving mechanism 80 may also be provided in the above-described sexual stimulation device of the sixth embodiment, the above-described sexual stimulation device of the second embodiment, the above-described sexual stimulation device of the third embodiment, the above-described sexual stimulation device of the fourth embodiment and the above-described sexual stimulation device of the fifth embodiment.

The above descriptions are merely preferred embodiments of the present disclosure. It should be noted that without departing from the principles of the present disclosure, various improvements and modifications may also be made. Various improvements and modifications should also be deemed as falling within the scope of protection of the present disclosure.

What is claimed is:

1. A sexual stimulation device comprising:
a shell defining a massaging space for accommodating a human body and being made of a flexible material, the shell comprising a first contacting portion and a second contacting portion, the massaging space defined at a region between the first contacting portion and the second contacting portion, and each of the first contacting portion and the second contacting portion is substantially breast-shaped; and
a massaging portion comprising a first moving portion and a second moving portion located at two opposite sides of the massaging space;
wherein the first contacting portion covers an outer side of the first moving portion, the second contacting portion covers an outer side of the second moving portion, the first moving portion and the second moving portion are opposite to each other and are spaced apart from each other in a first direction, at least one of the first moving portion and the second moving portion are movably arranged so as to cause the shell to deform, thereby massaging the human body located in the massaging space.

2. The sexual stimulation device according to claim 1, wherein the sex stimulation device further comprises two flexible connecting housings, and the flexible connecting housings cover outer surfaces of the first moving portion and the second first moving portion, the flexible connecting housings are received within the first contacting portion and the second contacting portion, and the flexible connecting housing has a hardness less than a hardness of the first moving portion and the second moving portion and greater than a hardness of the first contacting portion and the second contacting portion.

3. The sexual stimulation device according to claim 1, wherein the first contacting portion defines a first accommodating cavity and the second contacting portion defines a second accommodating cavity; the shell further comprises a base portion, the first contacting portion and the second contacting portion protrude from the base portion, and a cavity communicating with the first accommodating cavity and the second accommodating cavity is defined in the base portion.

4. The sexual stimulation device according to claim 3, wherein the sexual stimulation device further comprises an inner shell, the inner shell is a rigid inner shell, the base portion of the shell covers an outer side of the inner shell, and the inner shell is disposed in the cavity of the base portion.

5. The sexual stimulation device according to claim 1, wherein a vibration member is provided in at least one of the first contacting portion and the second contacting portion.

6. The sexual stimulation device according to claim 3, wherein a massaging cavity for accommodating the human body is further provided in the shell, at least one end of the massaging cavity is provided with a massage end, the massage end communicates with the massaging cavity, and the massage end is formed on an outer surface of the shell; the massage end is in the shape of a labia, a mouth, or an anus.

7. The sexual stimulation device according to claim 6, wherein the massaging cavity is defined in the base portion.

8. The sexual stimulation device according to claim 6, wherein the sexual stimulation device further comprises a vibration member arranged adjacent to the massaging cavity.

9. The sexual stimulation device according to claim 1, wherein at least one of the first moving portion and the second moving portion is swingable in an imaginary plane, so as to cause the shell to deform.

10. The sexual stimulation device according to claim 9, wherein at least one of the first moving portion and the second moving portion is swingable in the imaginary plane perpendicular to the first direction, so as to perform back-and-forth massage on the human body located in the massaging space.

11. The sexual stimulation device according to claim 10, wherein the sexual stimulation device further comprises a first driving mechanism, the first driving mechanism comprises a first driving member, a first transmission mechanism, and a sliding push rod, the first transmission mechanism is connected to the first driving member and the sliding push rod, and the first driving member is configured to drive the sliding push rod to perform linear reciprocating movement along a second direction perpendicular to the first direction; the first moving portion and the second moving portion are connected to the sliding push rod, the first moving portion and the second moving portion are rotatable about axes parallel to the first direction; the first moving portion and the second moving portion are provided with a first guide slot and a second guide slot respectively, and the sliding push rod is movably inserted into the first guide slot and the second guide slot so as to drive the first moving portion and the second moving portion to rotate around axes parallel to the first direction to perform reciprocating swing.

12. The sexual stimulation device according to claim 10, wherein the sexual stimulation device further comprises a first driving mechanism, the first driving mechanism comprises a first driving member, a first transmission mechanism, and a sliding push rod, the first moving portion and the second moving portion are fixed to the sliding push rod, the first transmission mechanism is connected to the first driving member and the sliding push rod; the first driving member is configured to drive the sliding push rod to rotate around the first direction to perform reciprocating swing in the imaginary plane so as to drive the first moving portion and the second moving portion to rotate around the first direction and perform reciprocating swing in the imaginary plane perpendicular to the first direction.

13. The sexual stimulation device according to claim 9, wherein at least one of the first moving portion and the second moving portion are swingable towards each other or away from each other to move closer to or away from each other in the first direction, so as to perform left-right massage on the human body located in the massaging space.

14. The sexual stimulation device according to claim 13, wherein the sexual stimulation device further comprises a first driving mechanism, the first driving mechanism comprises a first driving member, a first transmission mechanism, a first swing rod, and a second swing rod, the first transmission mechanism is connected to the first driving member, the first swing rod, and the second swing rod, and the first driving member is configured to drive the first swing rod and the second swing rod to swing in the imaginary plane in which the first direction lies; the first moving portion and the second moving portion are connected to the first swing rod and the second swing rod respectively so as to be driven thereby to move closer to or away from each other; the first transmission mechanism comprises a first bent shaft and a second bent shaft, the first bent shaft is connected to the first driving mechanism to be driven to rotate thereby, and the second bent shaft is connected to first driving mechanism to be driven to rotate thereby, the first bent shaft comprises a first neck portion, the first swing rod comprises a first ring, and the first ring is rotatably sleeved over the first neck portion; the second bent shaft comprises a second neck portion, the second swing rod comprises a second ring, and the second ring is rotatably sleeved over the second neck portion; each of the first bent shaft and the second bent shaft comprises a first shaft portion and a second shaft portion arranged at an angle, the first shaft portion of the first bent shaft is connected to first driving mechanism, the first shaft portion of the second bent shaft is connected to first driving mechanism, the second shaft portion of the first bent shaft is connected to the first swing rod, and the second shaft portion of the second bent shaft is connected to the second swing rod.

15. The sexual stimulation device according to claim 13, wherein at least one of the first moving portion and the second moving portion are swingable in an imaginary plane in which the first direction lies; the sexual stimulation device further comprises a first driving mechanism, the first driving mechanism comprises a first driving member, a first transmission mechanism, a first swing rod, and a second swing rod, the first transmission mechanism is connected to the first driving member, the first swing rod, and the second swing rod, and the first driving member is configured to drive, through the first transmission mechanism, the first swing rod and the second swing rod to rotate around a direction perpendicular to the first direction so as to perform reciprocating swing in the imaginary plane in which the first direction lies; the first moving portion and the second moving portion are connected to the first swing rod and the second swing rod respectively so as to be driven thereby to move closer to or away from each other.

16. The sexual stimulation device according to claim 15, wherein the first transmission mechanism comprises a first gear group, a rotating plate, a slider, a first linkage rod, a second linkage rod, and a reversing member, an input end of the first gear group is connected to an output shaft of the first driving member to be driven to rotate by the first driving member, an output end of the first gear group is connected to the rotating plate, an eccentric post is eccentrically formed on the rotating plate and the eccentric post is movably inserted into a first sliding slot of the slider, the eccentric post rotates with the rotating plate to drive the slider to perform reciprocating movement along the first direction, the first linkage rod is fixedly connected to the slider, and the second linkage rod is connected to the first linkage rod through the reversing member so as to drive the second linkage rod to perform reciprocating movement along the first direction; during moving, the first linkage rod and the second linkage rod move toward opposite direction; the first swing rod and the second swing rod are rotatably disposed about a third direction, the third direction is perpendicular to the first direction and an extension direction of the first swing rod; the first swing rod defines a second sliding slot, and the first linkage rod is provided with a first sliding post; the second swing rod defines a third sliding slot, and the second linkage rod is provided with a second sliding post; the first sliding post is movably inserted into the second sliding slot, and the second sliding post is movably inserted into the third sliding slot.

17. The sexual stimulation device according to claim 1, wherein the first moving portion is further connected to a first base block, and the second moving portion is further connected to a second base block; at least one of the first base block and the second base block is movable linearly in the first direction toward or away from the other.

18. The sexual stimulation device according to claim 17, wherein the sexual stimulation device further comprises a second driving mechanism, the second driving mechanism is connected to at least one of the first base block and the second base block to drive the at least one of the first base block and the second base block to move in the first direction; the second driving mechanism comprises a driving rod, a second end of the driving rod is in transmission connection with the first base block and the second base block, and is capable of driving the first base block and the second base block to move in opposite directions during movement.

19. The sexual stimulation device according to claim 17, wherein the second end of the driving rod is provided with a gear, each of the first base block and the second base block is provided with a first rack portion and a second rack portion, and the gear is configured to mesh with the first rack portion and the second rack portion, and the first rack portion and the second rack portion are disposed on two opposite sides of the gear respectively; the second end of the driving rod is further provided with a locking tooth portion adjacent to the gear, the operating handle and the driving rod are movably arranged so that the first rack portion and the second rack portion are selectively engageable with the gear or the locking tooth portion, and the driving rod is non-rotatable when the locking tooth portion engages with the first rack portion and the second rack portion.

20. A sexual stimulation device comprising:
a massaging portion, the massaging portion comprising a first moving portion and a second moving portion spaced apart from each other, outer surfaces of the first moving portion and the second moving portion being covered with a shell made of a flexible material;
wherein at least one of the first moving portion and the second moving portion is movably arranged to perform back-and-forth massage or left-right squeezing massage on a human body located between the first moving portion and the second moving portion, the shell is configured to directly contact the human body, and to perform back-and-forth friction massage or left-right squeezing massage on the human body located between the first moving portion and the second moving portion as the first moving portion and/or the second moving portion moves.
